(19) United States
(12) Patent Application Publication
(10) Pub. No.: US 2006/0176561 A1
(43) Pub. Date: Aug. 10, 2006

(54) Ultraviolet irradiation apparatus and optical device manufacturing apparatus

(75) Inventor: Masashi Kitabayashi, Azumino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/330,180

(22) Filed: Jan. 12, 2006

(30) Foreign Application Priority Data
Feb. 9, 2005 (JP) 2005-033263

(51) Int. Cl. G02B 5/18

(52) U.S. Cl. 359/569

(57) ABSTRACT

An ultraviolet irradiation apparatus that emits a luminous flux in an ultraviolet region, includes: an irradiation device body including a self-luminous element that emits a luminous flux in an ultraviolet region, a collector that, disposed on the luminous flux emergence side of the self-luminous element, focuses the luminous flux, and a metal fixing member that, providing a connection between the self-luminous element and the collector, is heat-transferably connected to the self-luminous element; and a moving mechanism that supports the irradiation device body and that moves the irradiation device body in a direction toward and away from an irradiation target.

### BACKGROUND

1. Technical Field

The present invention relates to an ultraviolet irradiation apparatus and an optical device manufacturing apparatus.

2. Related Art

The following projector has heretofore been known. That is, the projector comprises: an optical device including three light modulators (liquid crystal panels) which modulate each of three color lights of R, G, and B in response to image information and a color combination optical device (cross dichroic prism) which, having these light modulators attached thereto, combines the modulated three luminous fluxes to form an image light; and a projection optical device (projection lens) which enlarges and projects the formed image light.

In such a projector, to obtain a clear image, each liquid crystal panel must consistently be located at the back focus position of the projection lens. Besides, to obtain a clearer image, it is necessary to prevent pixel deviation from occurring between the liquid crystal panels.

Consequently, in manufacturing the projector, the focus adjustment of accurately arranging each liquid panel at the back focus position of the projection lens and the alignment adjustment of aligning the pixels of the liquid crystal panels are executed with high precision. And, an optical device manufacturing apparatus which manufactures an optical device by executing such adjustments has been known (e.g., see JP-A-2003-107395).

The optical device manufacturing apparatus described in JP-A-2003-107395 comprises: an adjustment light source device which introduces a luminous flux into a liquid crystal panel; a luminous flux detection device which detects the luminous flux passed through the liquid crystal panel and a cross dichroic prism; a position adjustment device which executes the focus/alignment adjustment of the liquid crystal panel based on the luminous flux detected by this luminous flux detection device; and an ultraviolet irradiation apparatus which fixes the liquid crystal panel to the cross dichroic prism after the focus/alignment adjustment.

The ultraviolet irradiation apparatus generally adopts the configuration in which a mercury vapor lamp is used as a light source which emits a luminous flux in an ultraviolet region, and the luminous flux emitted from the mercury vapor lamp is guided by an optical fiber. In manufacturing the optical device, the mercury vapor lamp is turned on after the focus/alignment adjustment. The luminous flux emitted from the mercury vapor lamp is guided by the optical fiber and irradiates the region wherein the cross dichroic prism and the liquid crystal panel are to be fixed. Thus, a UV cure adhesive applied between the cross dichroic prism and the liquid crystal panel is cured, fixing the liquid crystal panel to the cross dichroic prism.

However, in the aforementioned ultraviolet irradiaton device, the mercury vapor lamp is adopted as the light source which emits a luminous flux of an ultraviolet region, so that the limitation in the form of a discharge arc tube, a reflector, and the like prevents a reduction in the size of the light source. Besides, the optical fiber is used in addition to the aforementioned light source, thereby increasing the size of the ultraviolet irradiation apparatus.

Additionally, in the aforementioned ultraviolet irradiation apparatus, the leading end portion of the optical fiber which emits the guided luminous flux must be trailed around the wherein the cross dichroic prism and the liquid crystal panel are to be fixed. This reduces tractability, which prevents an improvement in convenience.

### SUMMARY

An advantage of some aspects of the invention is to provide an ultraviolet irradiation apparatus which enables a reduction in size and an improvement in convenience, and an optical device manufacturing apparatus.

An ultraviolet irradiation apparatus according to a first aspect of the invention is an ultraviolet irradiation apparatus that emits a luminous flux in an ultraviolet region, comprising: an irradiation device body and a moving mechanism. The irradiation device body includes a self-luminous element that emits a luminous flux in an ultraviolet region, a collector that, disposed on the luminous flux emergence side of the self-luminous element, focuses the luminous flux, and a metal fixing member that, providing a connection between the self-luminous element and the collector, is heat-transferably connected to the self-luminous element. The moving mechanism supports the irradiation device body and moves the irradiation device body in a direction toward and away from an irradiation target.

According to the first aspect of the invention, the ultraviolet irradiation apparatus includes the self-luminous element as a light source which emits a luminous flux in an ultraviolet region. Therefore, unlike the existing case, there is no limitation, in the form of a discharge arc tube, a reflector, and the like, which therefore allows the size of the light source itself to be reduced. Besides, the self-luminous element is used, thereby enabling low power consumption of the ultraviolet irradiation apparatus.

In addition, the ultraviolet irradiation apparatus includes the collector. Therefore, the luminous flux in an ultraviolet region emitted from the self-luminous element can be focused on a predetermined position, and there is thus no need to use the existing optical fiber.

Furthermore, the ultraviolet irradiation apparatus includes the metal fixing section, and the fixing section and the self-luminous element are heat-transferably connected to one another. Therefore, the heat generated in the self-luminous element can be released to the fixing section, which prevents the self-luminous element from sustaining thermal degradation, thus enabling increased longevity.

Still furthermore, the ultraviolet irradiation apparatus includes the moving mechanism. Therefore, the moving mechanism can make it easy to move the positions of the irradiation device bodies in a direction toward and away from the irradiation target, and thus to cause the collector to position the focus of the luminous flux at the irradiation target. Consequently, the luminous flux in an ultraviolet region can efficiently irradiate the irradiation target, and there is therefore no need to execute the existing troublesome operation of trailing an optical fiber around, which can improve convenience.

In an ultraviolet irradiation apparatus according to a second aspect of the invention, it is preferable that the moving mechanism includes a first moving section that is movable in a first axial direction toward and away from the irradiation target, and a second and a third moving section that are movable in a second and a third axial direction perpendicular to the first axial direction, respectively.

According to the second aspect of the invention, the moving mechanism includes the first, second, and third moving sections. Therefore, the position of the irradiation device bodies can be moved relative to the irradiation target not only in the first axial direction toward and away from the irradiation target, but also in the second and third axial directions perpendicular to the first axial direction. The position at which the luminous flux is focused by the collector can be more easily positioned relative to the irradiation target with a simpler configuration. This can further improve convenience.

In an ultraviolet irradiation apparatus according to a third aspect of the invention, it is preferable that the moving mechanism include a first moving section that is movable in a first axial direction toward and away from the irradiation target, and a support plate that, connected to the first moving section, extends along a plane perpendicular to the first axial direction. And, it is also preferable that a plurality of recesses that allow the irradiation device body to be fitted therein are formed in an end face of the support plate which extends along the plane.

According to the third aspect of the invention, the moving mechanism includes the first moving section and the support plate, and the plurality of recesses are formed on an end face of the support plate, which extends along a plane perpendicular to the first axial direction along which the first moving section moves. Therefore, as the arrangement positions of the irradiation device bodies relative to the plurality of recesses are changed, the arrangement positions of the irradiation device bodies can be changed along a plane perpendicular to the first axial direction. The position of the irradiation device bodies can thus be moved relative to the irradiation target not only in the first axial direction toward and away from the irradiation target, but also in a direction along a plane perpendicular to the first axial direction. The position of focusing the luminous flux by the collector can therefore be more easily positioned relative to the irradiation target. This can further improve convenience.

In addition, the aforementioned configuration eliminates the need for the mechanism of moving the irradiation device bodies along a plane perpendicular to the first axial direction, thus making it possible to easily manufacture the ultraviolet irradiation apparatus and also to reduce its manufacturing cost.

In an ultraviolet irradiation apparatus according to a fourth aspect of the invention, it is preferable that a plurality of the irradiation device bodies are provided, and that the moving mechanism includes a first moving section that is movable in a first axial direction toward and away from the irradiation target, and a support plate that, connected to the first moving section, extends along a plane perpendicular to the first axial direction. And, it is also preferable that the plurality of irradiation device bodies are spaced a predetermined distance apart on an end face of the support plate which extends along the plane.

According to the fourth aspect of the invention, the moving mechanism includes the first moving section and the support plate, and the plurality of irradiation device bodies are spaced a predetermined distance apart on an end face of the support plate which extends along a plane perpendicular to the first axial direction. Therefore, the positions of the support plate and the plurality of irradiation device bodies are moved in a direction toward and away from the irradiation target by the first moving section to position the plurality of irradiation device bodies at positions corresponding to the focal length of the luminous flux from the collector. And, out of the plurality of irradiation device bodies, the luminous flux in the ultraviolet region is emitted from a predetermined irradiation device body disposed at a position corresponding to the irradiation target. The luminous flux of the ultraviolet region can thereby easily irradiate the irradiation target.

In addition, the aforementioned configuration eliminates the need for the mechanism of moving the irradiation device bodies along a plane perpendicular to the first axial direction, thus making it possible to easily manufacture the ultraviolet irradiation apparatus.

Furthermore, the aforementioned configuration eliminates the need for the operation of changing the arrangement position of the irradiation device bodies along a plane perpendicular to the first axial direction, thus enabling a further improvement in convenience.

An ultraviolet irradiation apparatus according to a fifth aspect of the invention is an optical device manufacturing apparatus for manufacturing an optical device including a plurality of light modulators that modulate each of plural color lights in response to image information and a color combination optical device that combines the color lights modulated by the light modulators to form an image light. The apparatus comprises: a holding section, a position adjustment section, an adjustment light source device, and an ultraviolet irradiation apparatus according to the first aspect. The holding section holds the color combination optical device. The position adjustment section, holding the light modulators, executes the position adjustment of the light modulators relative to the color combination optical device. The adjustment light source device introduces a position adjustment luminous flux into the light modulators. And, the ultraviolet irradiation apparatus emits a luminous flux in an ultraviolet region to cure a UV cure adhesive interposed between the light modulators and the color combination optical device.

According to the fifth aspect of the invention, the manufacturing apparatus includes the holding section, the position adjustment section, the adjustment light modulator, and the aforementioned ultraviolet irradiation apparatus, and can thus enjoy the same operation and effect as those of the aforementioned ultraviolet irradiation apparatus.

In addition, the manufacturing apparatus includes the aforementioned ultraviolet irradiation apparatus. Therefore, the irradiation device bodies are moved by the moving mechanism of the ultraviolet irradiation apparatus. This makes it possible to easily position the irradiation device bodies at the irradiation positions corresponding to the model of the optical device which provides the manufacturing target, i.e., corresponding to the size of the optical device, thus enabling the manufacture of various optical device bodies.

### BRIEF DESCRIPTION OF THE DRAWINGS

The invention will be described with reference to the accompanying drawings, wherein like numbers reference like elements.

FIG. 1 is a schematic view of the structure of a projector, including an optical device provided as a manufacturing target, according to a first embodiment.

FIG. 2 is an exploded perspective view showing the structure of an optical device body according to the

FIG. 3 is a view showing an optical device body manufacturing apparatus according to the embodiment.

FIG. 4 is a view showing the optical device body manufacturing apparatus according to the embodiment.

FIG. 5 is a view showing the optical device body manufacturing apparatus according to the embodiment.

FIG. 6 is a view showing the optical device body manufacturing apparatus according to the embodiment.

FIG. 7 is a view showing the structure of a six-axis position adjustment device according to the embodiment.

FIG. 8 is a front view of the proximal portion of a liquid crystal panel holding section according to the embodiment.

FIG. 9 is a view showing the structure of a luminous flux detection device according to the embodiment.

FIG. 10 is a view showing the structure of the luminous flux detection device according to the embodiment.

FIG. 11 is a block diagram showing the structure of control exerted by an adjustment control device according to the embodiment.

FIG. 12 is a view showing the structure of a first irradiation device according to the embodiment.

FIG. 13 is a view showing the structure of an irradiation device body according to the embodiment.

FIG. 14 is a view showing the structure of the irradiation device body according to the embodiment.

FIG. 15 is a view showing the structure of the irradiation device body according to the embodiment.

FIG. 16 is a perspective view showing the structure of a support plate according to the embodiment.

FIG. 17 is a block diagram showing the structure of control exerted by an irradiation control device according to the embodiment.

FIG. 18 is a flowchart illustrating an optical device body manufacturing method according to the embodiment.

FIG. 19 is a flowchart illustrating the method of adjusting the position of each light modulator according to the embodiment.

FIG. 20 is a view showing an example of an image taken by each CCD camera according to the embodiment.

FIG. 21 is a view showing an example of an image taken by each CCD camera according to the embodiment.

FIG. 22 is a view illustrating the method of provisionally fixing each light modulator to a cross dichroic prism by a provisional fixing section according to the embodiment.

FIG. 23 is a view illustrating the method of provisionally fixing each light modulator to the cross dichroic prism by the provisional fixing section according to the embodiment.

FIG. 24 is a flowchart illustrating the method of fixing each light modulator according to the embodiment.

FIG. 25 is a view showing the state in which each irradiation device body is positioned at an irradiation position according to the embodiment.

FIG. 26 is a view showing the state in which each irradiation device body is positioned at the irradiation position according to the embodiment.

FIG. 27 is a perspective view showing the structure of a second irradiation device according to a second embodiment.

### DESCRIPTION OF EXEMPLARY EMBODIMENTS

### First Embodiment

A first embodiment of the invention will hereafter be described with reference to the drawings.

1. Configuration of Projector

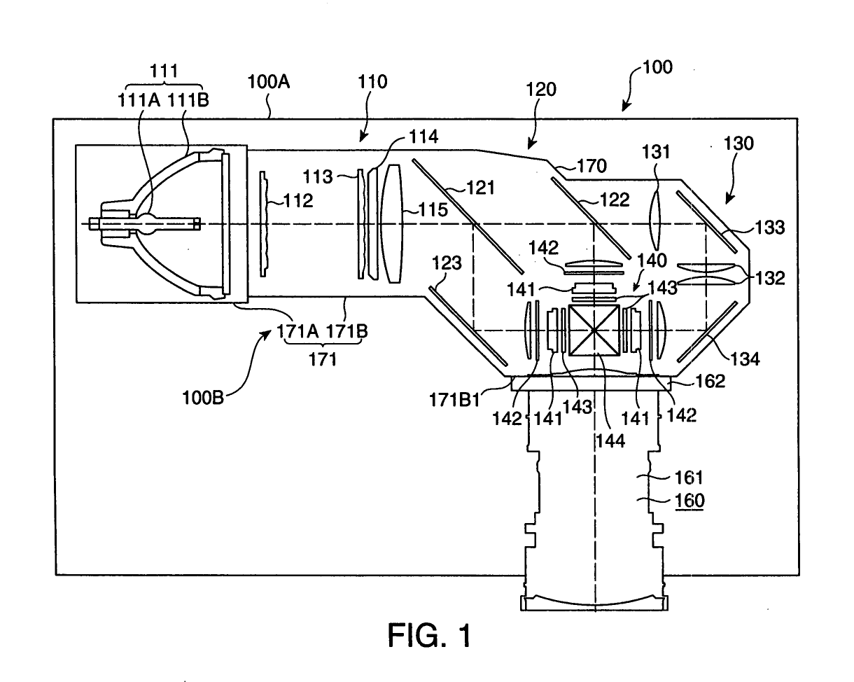

FIG. 1 is a schematic view showing the structure of a projector 100, including an optical device to be manufactured, according to the first embodiment.

The projector 100 modulates a luminous flux emitted from a light source, to form a color image in response to image information, and enlarges and projects the formed color image onto a screen (not shown). As shown in FIG. 1, this projector 100 includes an exterior casing 100A and an optical unit 100B.

Although not shown in FIG. 1, inside the exterior casing 100A, and disposed in a space other than that occupied by the optical unit 100B, are a power supply unit for supplying external power to the components of the projector 100, a cooling unit for cooling the inside of the projector 100, a control board for controlling the entire projector 100, and the like.

The exterior casing 100A, made of a synthetic resin prepared by injection molding, is formed into a generally rectangular parallelepiped shape to hold the optical unit 100B. This exterior casing 100A includes an upper casing and a lower casing. The upper casing constitutes the top surface, the front surface, the back surface, and the side surfaces of the projector 100. The lower casing constitutes the bottom surface, the front surface, the side surfaces, and the back surface of the projector 100. The upper and lower casings are fixed to one another by a screw or the like.

The exterior casing 150A is not limited to being made of synthetic resin, but may be formed of another material, for example, metal.

The optical unit 100B modulates a luminous flux emitted from a light source device, to form a color image in response to the image information, and enlarges and projects the formed color image onto the screen via a projection lens. As shown in FIG. 1, this optical unit 100B includes an integrator illumination optical system 110, a color separation optical device 120, a relay optical system 130, an optical device 140, a projection lens 160, and an optical component housing 170.

The integrator illumination optical system 110 is an optical system for rendering the luminous flux, emitted from the light source, uniform in luminance on a plane perpendicular to the illumination optical axis. This integrator illumination optical system 110 includes the light source device 111 including a light source lamp 111A and a reflector 111B, a first lens array 112, a second lens array 113, a polarization converter 114, and a superimposed lens 115. The luminous flux emitted from the light source lamp 111A is oriented in an exit direction by the reflector 111B and divided into a plurality of partial luminous fluxes by the first lens array 112, and the partial luminous fluxes are focused in the vicinity of the second lens array 113. The partial luminous fluxes emitted from the second lens array 113 enter the downstream polarized converter 114 with their central axis (principal ray) perpendicular to the incidence plane of the polarization converter 114. The partial luminous fluxes are converted by the polarization converter 114 into linear polarized light of substantially one kind, and are then emitted from the polarization converter 114 as the linear polarized light. The plurality of partial luminous fluxes, thus emitted from the polarization converter 114 as the linear polarized light, pass through the superimposed lens 115 and are then superimposed one over another onto to-be-described three liquid crystal panels of the optical device 140.

The color separation optical device 120, including two dichroic mirrors 121 and 122 and a reflecting mirror 123, has the function of causing the dichroic mirrors 121 and 122 and the reflecting mirror 123 to separate the plurality of partial luminous fluxes, emitted from the integrator illumination optical system 110, into three color lights of red, green, and blue.

The relay optical system 130, including an incidence side lens 131, a relay lens 133, and reflecting mirrors 133 and 134, has the function of leading the color lights, separated by the color separation optical device 120, to the to-be-described liquid crystal panels.

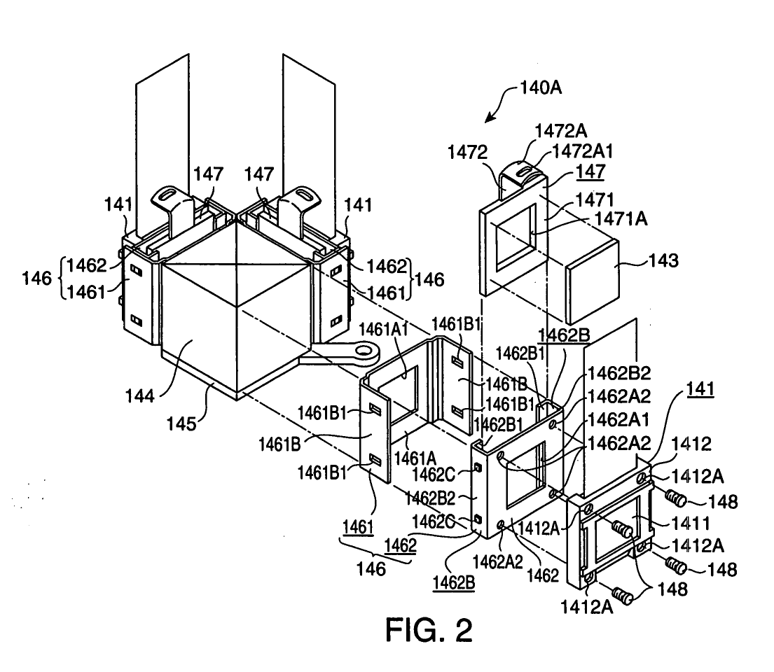

The optical device 140 modulates the three color lights, emitted from the color separation optical device 120, in response to the image information, combines the modulated color lights to form a color image, and enlarges and projects the formed color image. As shown in FIG. 1, this optical device 140 includes three light modulators 141, each having a liquid crystal panel 1411 (FIG. 2), an incidence side polarizing plate 142 and an emergence side polarizing plate 143 which are disposed on the luminous flux incidence and emergence sides of each of these light modulators 141, as well as a cross dichroic prism 144 serving as the color combination optical device. Out of these components, the three light modulators 141, the three emergence side polarizing plates 143, and the cross dichroic prism 144 are integrated to configure an optical device body 140A (FIG. 2). The detailed configuration of this optical device body 140A will be described later. Additionally, the optical device body 140A may adopt the configuration of integrating the three incidence side polarizing plates 142 in addition to the three light modulators 141, the three emergence side polarizing plates 143, and the cross dichroic prism 144.

The color lights with their polarization directions oriented mainly in one direction by the polarization converter 114 are each made incident on the incidence side polarizing plate 142. Out of the incident luminous fluxes, the incidence side polarizing plate 142 transmits only polarized light having substantially the same direction as the polarization axis of the luminous fluxes oriented in one direction by the polarization converter 114, and absorbs the other luminous fluxes. This incidence side polarizing plate 142 is configured, for example, to have a polarizing film attached on a light transmissive substrate of sapphire glass, crystal, or the like.

Although not specifically shown, the liquid crystal panel 1411 configuring the light modulator 141 has the configuration in which crystals serving as an electrooptic material are hermetically sealed between a pair of transparent glass substrates. The orientation of the crystals are controlled in response to a drive signal transmitted from the control board (not shown), thus modulating the polarization direction of the polarized luminous fluxes emitted from the incidence side polarizing plate 142.

The emergence side polarizing plate 143 has the same general configuration as the incidence side polarizing plate 142. Out of the luminous fluxes emitted from the light modulator 141, the emergence side polarizing plate 143 transmits only a luminous flux having a polarization axis perpendicular to the transmission axis of the luminous fluxes made incident on the incidence side polarizing plate 142, and absorbs the other luminous fluxes.

The cross dichroic prism 144 is an optical element which forms a color image by combining optical images modulated for each color light emitted from the emergence side polarizing plate 143. This cross dichroic prism 144 is formed into a square shape in plan view which is obtained by attaching four right angle prisms together, and two dielectric multilayer films are formed on the interfaces obtained by attaching the right angle prisms together. These dielectric multilayer films reflect the color light which has been emitted from the light modulator 141 located opposite the projection lens 160 and which has passed through its emergence side polarizing plate 143, and transmit the color lights which have been emitted from the remaining two light modulators 141 and which have passed through their emergence side polarizing plates 143. Thus the color lights modulated by the respective light modulators 141 are combined to form the color image.

The projection lens 160, configured as a combination lens having a plurality of lenses housed in a tubular lens barrel 161, enlarges and projects the color image modulated by the optical device 140 in response to the image information. As shown in FIG. 1, this projection lens 160 includes a flange 162 having a generally rectangular shape in plan view which widens outward from a peripheral portion of the lens barrel 161 on the proximal end side thereof.

While not specifically shown, the lens barrel 161 is configured by connecting a plurality of members, wherein the plurality of members support the plurality of lenses. Out of the plurality of members, at least two members are configured to be rotatable relative to the other members. The projection lens 160 is configured such that the relative position of the plurality of lens can be varied by rotating the at least two members to adjust the magnification and focus of a projected image.

As shown in FIG. 1, the optical component housing 170, made of a synthetic resin prepared by injection molding, includes a component housing member 171 and a lid-like member (not shown).

The component housing member 171 includes a light source housing section 171A for housing the light source device 111 and a component housing section 171B which, formed into a container, houses the optical components 110, 120, 130, and 140 but excludes the light source device 111.

The light source housing section 171A, having a generally box-like shape, has openings formed in an end face thereof facing the component housing section 171B side and in an end face on the component housing section 171B opposite this end face, respectively. The opening formed in the end face on the component housing section 171B is used to transmit the luminous flux emitted from the light source device 111. The opening formed in the end face opposite this end face on the component housing section 171B is used to house the light source device 111 in such a manner that it is pushed into the light source housing section 171A from this side thereof.

The component housing section 171B, having an open-topped, generally rectangular parallelepiped shape, has one end connected to the light source housing section 171A. Additionally, although not shown, an attachment portion for attaching the optical device body 140A is formed on the bottom surface of this component housing section 171B on the other end side thereof. Furthermore, a lens attachment portion 171B1 for attaching the projection lens 160 is formed on the side surface of this component housing section 171B on the other end side thereof. The lens attachment portion 171B1 and the flange 162 of the projection lens 160 are fixed by a screw or the like, thereby attaching the projection lens 160 to the optical component housing 170. Still furthermore, although not shown, formed inside the side surface of this component housing section 171B are a plurality of grooves into which optical components 112 to 115, 121 to 123, 131 to 134, and 142 are slidingly fitted from above.

The lid-like member is a plate-like member which closes the upper opening portion of the component housing section 171B. This lid-like member has an opening formed above the optical device body 140A housed in the component housing section 171B, wherein three polarizing plate supports (to be described), which configure the optical device body 140A, are rotatably supported on the periphery of this opening.

1-1. Configuration of Optical Device Body

FIG. 2 is an exploded perspective view showing the structure of the optical device body 140A. FIG. 2 shows in exploded form the light modulator 141, the emergence side polarizing plate 143, a light modulator support 146, and the polarizing plate support 147 which are disposed on one of three luminous flux incidence side end faces of the cross dichroic prism 144. However, the light modulators 141, the emergence side polarizing plates 143, the light modulator supports 146, and the polarizing plate supports 147, which are disposed on the other two luminous flux incidence side end faces, also have the same structure.

In addition to the aforementioned three light modulators 141, three emergence side polarizing plates 143, and cross dichroic prism 144, the optical device body 140A includes a support structural body 145, the three light modulator supports 146, and the three polarizing plate supports 147. These members 141 and 143 to 147 are integrated to form the optical device body 140A.

As shown in FIG. 2, the three light modulators 141 each have the configuration in which the liquid crystal panel 1411 is housed in a holding frame 1412. As shown in FIG. 2, in each light modulator 141, fixing holes 1412A for attaching the light modulator 141 to the light modulator support 146 are formed at four corner positions of the holding frame 1412.

As shown in FIG. 2, the support structural body 145, having a generally rectangular parallelepiped shape, is a member which, having the cross dichroic prism 144 mounted in position on its top surface, is used to attach the entire optical device body 140A to the aforementioned attachment portion of the optical component housing 170.

Although not specifically shown, a spherical bulge is formed on the top surface of this support structural body 145. The underside of the cross dichroic prism 144 is abutted with the bulge, thereby making it possible to adjust the vertical position of the cross dichroic prism 144 relative to the support structural body 145. To fix the cross dichroic prism 144 to such a support structural body 145, for example, a UV cure adhesive is filled between the underside of the cross dichroic prism 144 and the aforementioned bulge. The adjustment of the position of the cross dichroic prism 144 relative to the support structural body 145 is then executed with the UV cure adhesive uncured. As such position adjustment, for example, the following position adjustments can be adopted. That is, an image of the top surface of the cross dichroic prism 144 is taken by a CCD camera or the like, and based on the image taken, the cross dichroic prism 144 is moved relative to the support structural body 145 so that a cross-like shape in plan view formed by two dielectric multilayer films on the top surface of the cross dichroic prism 144 is located in position. Alternatively, a luminous flux is led into each luminous flux incidence side end face of the cross dichroic prism 144, a luminous flux emitted from each luminous flux emergence side end face thereof is detected by the CCD camera or the like, and based on the detected luminous flux, the cross dichroic prism 144 is moved relative to the support structural body 145. After the position adjustment, the UV cure adhesive is irradiated with a luminous flux in the ultraviolet region and is thereby cured, thus fixing the cross dichroic prism 144 to the support structural body 145.

The three light modulator supports 146 are members which, each disposed between the light modulator 141 and the cross dichroic prism 144, are used to fix the light modulator 141 to the cross dichroic prism 144. As shown in FIG. 2, the light modulator supports 146 each include a first support 1461 and a second support 1462.

As shown in FIG. 2, the first support 1461 includes a plate-like portion 1461A, having a rectangular shape in plan view, and projecting portions 1461B which project toward the luminous flux incidence side from both left and right end edges of the plate-like portion 1461A.

As shown in FIG. 2, an opening, having a rectangular shape in plan view, for transmitting a luminous flux is formed in the approximately central area of the plate-like portion 1461A.

As shown in FIG. 2, two upper and lower apertures 1461B1 are formed in each projecting portion 1461B. As shown in FIG. 2, these apertures 1461B1 have a rectangular shape in plan view extending along the direction of projection of the projecting portions 1461B.

The first support 1461 supports the second support 1462 using the projecting portions 1461B. Besides, the luminous flux emergence side end face of the plate-like portion 1461A of the first support 1461 abuts the luminous flux incidence side end face of the cross dichroic prism 144 via the UV cure adhesive. And, after the alignment adjustment of the liquid crystal panel 1411 is executed using the aforesaid end faces as sliding surfaces, the UV cure adhesive is cured, and the first support 1461 is thereby fixed to the cross dichroic prism 144.

As shown in FIG. 2, the second support 1462 includes a plate-like portion 1462A having a rectangular shape in plan view and projecting portions 1462B which project toward the luminous flux emergence side from both left and right end edges of the plate-like portion 1462A. The second support 1462 is inserted between the projecting portions 1461B of the first support 1461.

As shown in FIG. 2, an opening 1462A1 having a rectangular shape in plan view for transmitting a luminous flux is formed in the approximately central area of the plate-like portion 1462A. As shown in FIG. 2, fixing holes 1462A2 for fixing the light modulator 141 are formed in the vicinities of four corner positions of this opening 1462A1. The second support 1462 and the holding frame 1412 of the light modulator 141 are connected by screws 148 (FIG. 2) via the fixing holes 1462A2 and the fixing holes 1412A formed in the holding frame 1412, thereby fixing the light modulator 141 to the second

In the projecting portions 1462B, as shown in FIG. 2, the leading end portions 1462B1 thereof are bent generally parallel to the plate-like portion 1462A and extend toward each other.

Additionally, in response to the apertures 1461B1 of the first support 1461, as shown in FIG. 2, two upper and lower raised portions 1262C are formed on the outer side surface of a proximal portion 1462B2 of each projecting portion 1462B. When the second support 1462 is located between the projecting portions 1461B of the first support 1461, these raised portions 1462C freely fit in the apertures 1461B1. The raised portions 1462C have a rectangular shape in plan view which is smaller than the outside dimension of the apertures 1461B1. With the UV cure adhesive applied between the apertures 1461B1 and the raised portions 1462C, the focus adjustment of the liquid panel 1411 is executed by sliding the raised portions 1462C relative to the apertures 1461B1. Thereafter, the UV cure adhesive is cured, thereby fixing the second support 1462 to the first support 1461.

The three polarizing plate supports 147 are each located between the plate-like portion 1462A of the second support 1462 and the leading end portions 1462B1 of the projecting portion 1462B thereof. The three emergence side polarizing plates 143 are thus held and pivotally supported on the lid-like member of the optical component housing 170, making it possible to execute the position adjustment of the emergence side polarizing plates 143. As shown in FIG. 2, these polarizing plate supports 147 each include a plate-like portion 1471 having a rectangular shape in plan view and a projecting portion 1472 extending upward parallel to the plate surface of the plate-like portion 1471 from the approximate center of the upper edge of the plate-like portion 1471.

As shown in FIG. 2, an opening 1471A, having a rectangular shape in plan view, for transmitting a luminous flux is formed in the approximately central area of the plate-like portion 1471. The emergence side polarizing plate 143 is fixed by an adhesive, a two-sided tape, or the like to the periphery of this opening 1471A on the luminous flux incidence side thereof.

The projecting portion 1472 has its leading end portion 1472A bent generally normal to the plate surface of the plate-like portion 1471.

As shown in FIG. 2, this leading end portion 1472A, which is convex, is formed into a circularly arcuate shape in plan view centered about the optical axis of a luminous flux incident from the emergence side polarizing plate 143. The lower end face of this leading end portion 1472A abuts a support (not shown) formed on the top surface of the lid-like member of the optical component housing 170, and the leading end portion 1472A is slidably supported on this support, thereby making it possible to adjust the position of the emergence side polarizing plate 143 around the optical axis within a plane perpendicular to this optical axis. This support has a support surface corresponding to the shape of the leading end portion 1472A of the projection portion 1472.

In addition, as shown in FIG. 2, formed in this leading end portion 1472 is a track hole 1472A1 which penetrates from the upper end face to the lower end face and extends in the direction in which the leading end portion 1472A slides. After the position adjustment of the emergence side polarizing plate 143 is executed by sliding the leading end portion 1472A of the polarizing plate support 147 with respect to the aforementioned support, the leading end portion 1472A is fixed by a screw or the like to this support via the track hole 1472A1, thereby fixing the polarizing plate support 147 to the lid-like member.

In this embodiment, the configuration is such that the emergence side polarizing plate 143 is supported on the polarizing plate support 147, but is not limited to such a configuration. The configuration may be such that another optical converter, e.g., a viewing angle correcting plate is supported on the polarizing plate support 147, and such that the position adjustment of the viewing angle correcting plate is executed using the polarizing plate support 147.

In the optical device body 140A having the aforementioned structure, to adhere and fix the liquid crystal panels 1411 to the cross dichroic prism 144 via the light modulator supports 146, it is necessary to execute the focus adjustment, alignment adjustment, and fixing of the liquid crystal panels 1411. Therefore, this requires a manufacturing apparatus capable of executing the focus adjustment, alignment adjustment, and fixing of the liquid crystal panels 1411. A description will hereafter be given of the configuration of the manufacturing apparatus for manufacturing the optical device body 140A.

2. Structure of Optical Device Body Manufacturing Apparatus

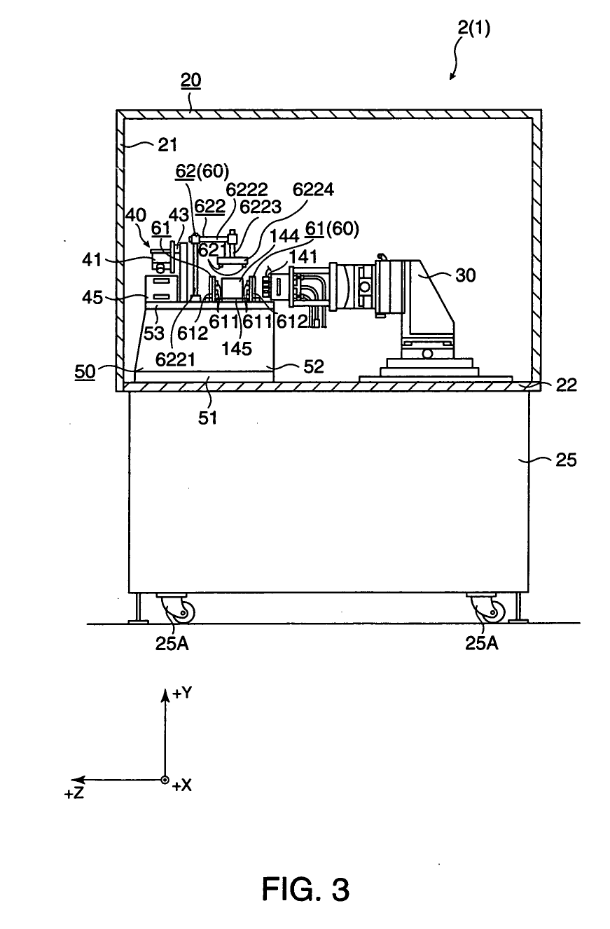

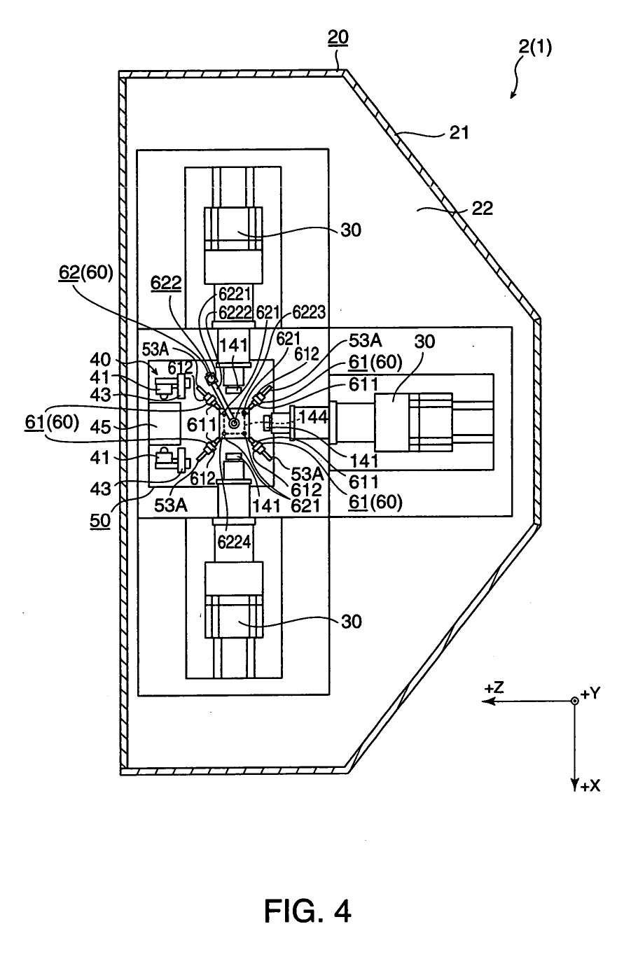

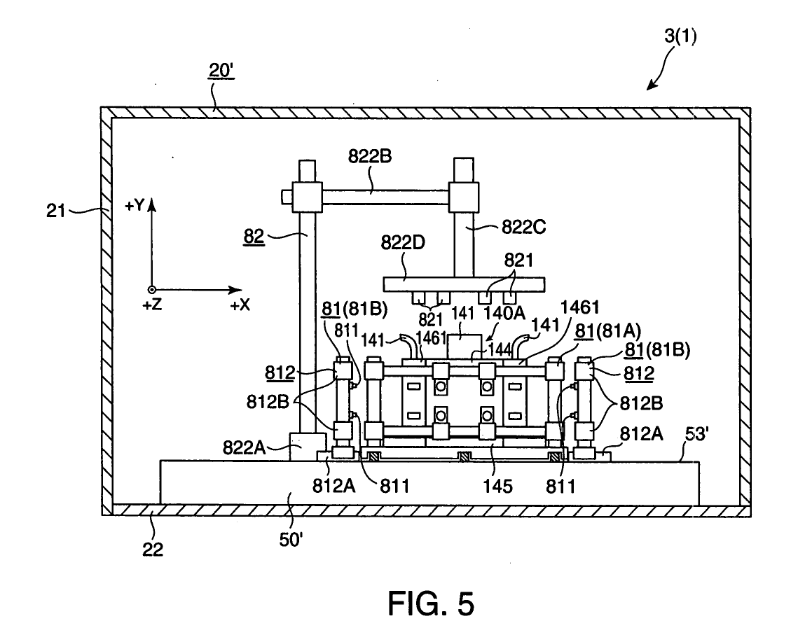

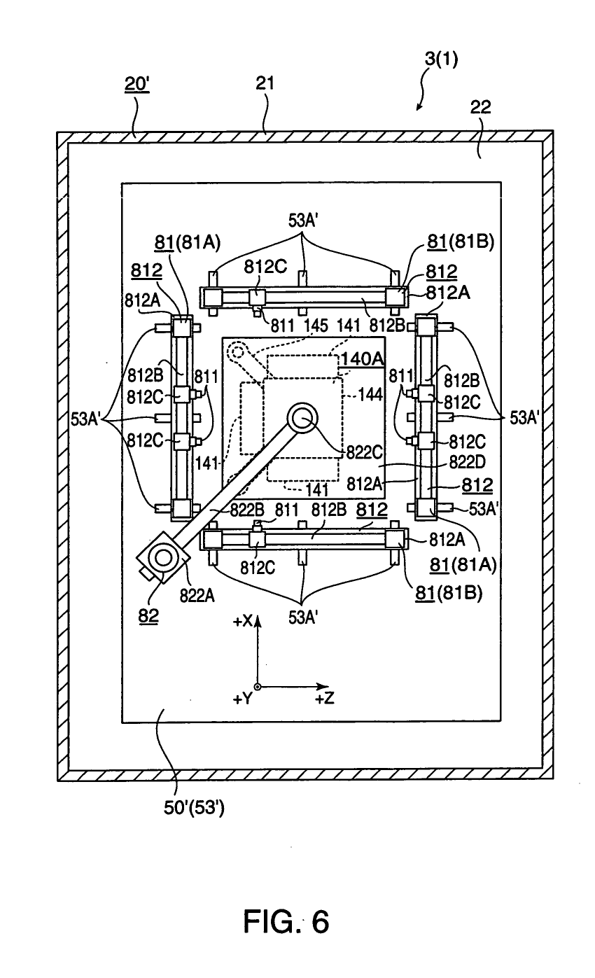

FIGS. 3 to 6 are views showing a manufacturing apparatus 1 for manufacturing the optical device body 140A. Specifically, FIG. 3 is a side view of an adjustment apparatus 2 configuring the manufacturing apparatus 1, and FIG. 4 is a plan view of the adjustment apparatus 2 as seen from above. Besides, FIG. 5 is a side view of a permanent fixing apparatus 3 configuring the manufacturing apparatus 1, and FIG. 6 is a plan view of the permanent fixing apparatus 3 as seen from above. In FIGS. 3 to 6, the optical axis of a luminous flux emitted from the optical device body 140A is indicated by a Z-axis, and two mutually perpendicular axes perpendicular to the Z-axis are indicated by an X-axis and a Y-axis.

As shown in FIGS. 3 to 6, the manufacturing apparatus 1 includes the adjustment apparatus 2 (FIGS. 3 and 4) which executes the focus and alignment adjustment of the liquid crystal panels 1411, and the permanent fixing apparatus 3 (FIGS. 5 and 6) which, serving as the ultraviolet irradiation apparatus, fixes the liquid crystal panels 1411 to the cross dichroic prism 144.

2-1. Structure of Adjustment Apparatus

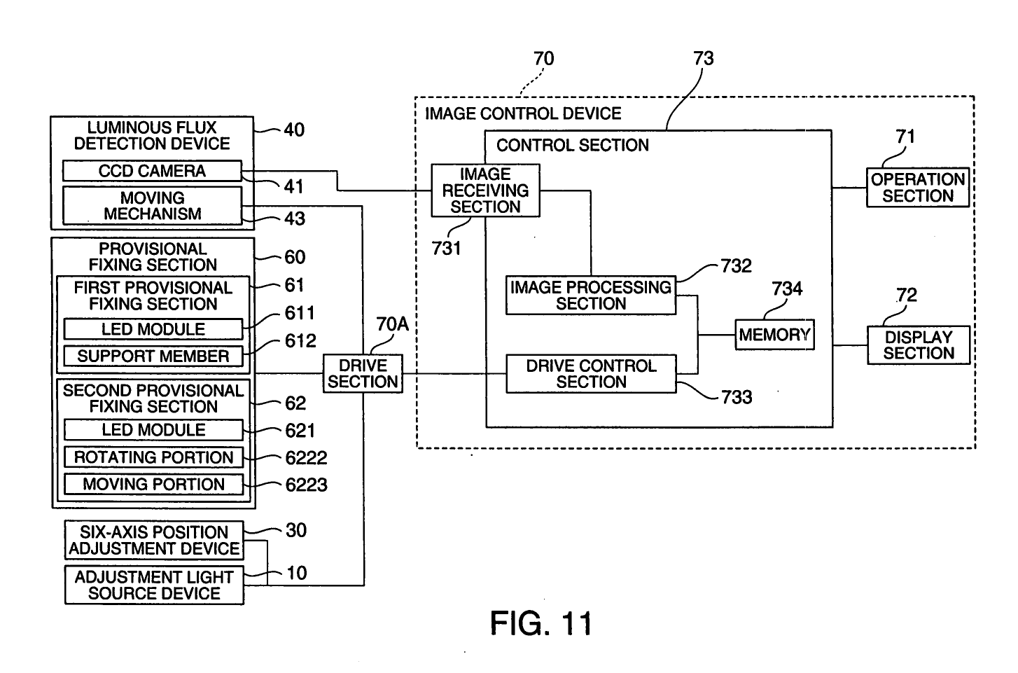

As shown in FIG. 3 or 4, the adjustment apparatus 2 includes a UV light-shielding cover 20, three six-axis position adjustment devices 30 serving as the position adjustment sections, a luminous flux detection device 40, a mounting section 50 serving as the holding section, a provisional fixing section 60, adjustment light source devices 10 (see FIG. 11), and an adjustment control device 70 (see FIG. 11) which controls the operation of these devices and processes an image.

The UV light-shielding cover 20 includes a side plate 21 which surrounds the six-axis position adjustment devices 30, the luminous flux detection device 40, the mounting section 50, and the provisional fixing section 60, a bottom plate 22, and a mounting stand 25 provided below the bottom plate 22. The side plate 21 is provided with an openable/closable door (not shown). This door, used for material supply/removal from the optical device body 140A, is formed of an acrylic plate or the like which is not transmissive to ultraviolet radiation. Additionally, the mounting stand 25 has casters 25A (FIG. 3) below it so that the adjustment apparatus 2 can easily be moved.

The adjustment light source devices 10 are light sources which emit position adjustment luminous fluxes for use in adjusting the position of the light modulators 141 (liquid crystal panels 1411). The adjustment light source devices 10, each including, for example, a discharge arc lamp, such as a metal halide lamp, and a self-luminous lamp, are driven by a drive section (not shown) such as a light source drive circuit. The adjustment light source devices 10 supply the color lights of R, G, and B to the three six-axis position adjustment devices 30 to irradiate the liquid crystal panels 1411 with the color lights corresponding to the light modulators (liquid crystal panels 1411), respectively.

2-1-1. Structure of Six-Axis Position Adjustment Device

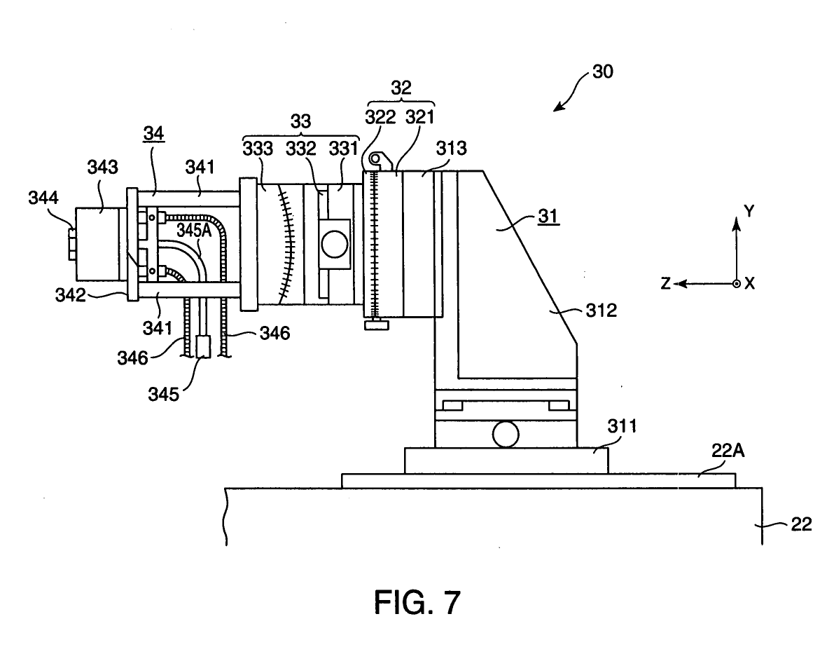

FIG. 7 is a view showing the structure of the six-axis position adjustment device 30. In FIG. 7, for brevity of description, a direction perpendicular to the plane of FIG. 7 is indicated by an X-axis, a left and right direction as seen in FIG. 7 is indicated by a Z-axis, and an up and down direction as seen in FIG. 7 is indicated by a Y-axis.

The three six-axis position adjustment devices adjust the arrangement positions of the light modulators 141 (liquid crystal panels 1411) relative to the luminous flux incidence side end faces of the cross dichroic prism 144.

As shown in FIG. 7, the six-axis position adjustment device 30 includes a plan position adjustment section 31 positioned to be movable along a rail 22A on the bottom plate 22 of the UV light-shielding cover 20, an in-plane rotational position adjustment section 32 provided in the leading end portion of this plan position adjustment section 31, an out-of-plane rotational position adjustment section 33 provided in the leading end portion of this in-plane rotational position adjustment section 32, and a liquid crystal panel holding section 34 provided in the leading end portion of this out-of-plane rotational position adjustment section 33.

The plan position adjustment section 31 adjusts the advance/retraction position and plan position of the light modulator 141 (liquid crystal panel 1411) relative to the luminous flux incidence side end face of the cross dichroic prism 144. As shown in FIG. 7, this plan position adjustment section 31 includes a base 311 slidably positioned on the bottom plate 22, a leg 312 vertically set on this base 311, and a connection 313 which, provided in the upper leading end portion of this leg 312, is connected with the in-plane rotational position adjustment section 32.

The base 311 is moved in the Z-axis direction of the bottom plate 22 by a drive section (not shown) such as a motor (not shown). The leg 312 is moved in an X-axis direction relative to the base 311 by a drive section (not shown) such as a motor provided in a side portion. The connection 313 is moved in a Y-axis direction relative to the leg 312 by a drive section (not shown) such as a motor.

The in-plane rotational position adjustment section 32 adjusts the in-plane-direction rotational position of the light modulator 141 (liquid crystal panel 1411) relative to the luminous flux incidence side end face of the cross dichroic prism 144. As shown in FIG. 7, this in-plane rotational position adjustment section 32 includes a cylindrical proximal portion 321 fixed to the leading end portion of the plan position adjustment section 31, and a rotation adjustment portion 322 provided so as to be rotatable in the circumferential direction of this proximal portion 321.

Out of these portions, the rotation adjustment portion 322 is rotated on an XY plane relative to the proximal portion 321 by the drive section (not shown) such as a motor provided in a side portion, and the in-plane rotational position of the light modulator 141 (liquid crystal panel 1411) is thus adjusted relative to the luminous flux incidence side end face of the cross dichroic prism 144.

The out-of-plane rotational position adjustment section 33 adjusts the out-of-plane-direction rotational position of the light modulator 141 (liquid crystal panel 1411) relative to the luminous flux incidence side end face of the cross dichroic prism 144. As shown in FIG. 5, this out-of-plane rotational position adjustment section 33 include a proximal portion 331, a first adjustment portion 332, and a second adjustment portion 333. The proximal portion 331 is fixed to the leading end portion of the in-plane rotational position adjustment section 32 and has its leading end portion formed with a concave surface providing a circular arc in a horizontal direction. The first adjustment portion 332, provided slidably along the circular arc on the concave surface of this proximal portion 331, has its leading end portion formed with a concave surface providing a circular arc in a vertical direction. The second adjustment portion 333 is provided slidably along the circular arc on the concave surface of this first adjustment portion 332.

When a drive section (not shown), such as a motor provided in a side portion of the proximal portion 331, is activated, the first adjustment portion 332 slides. When a drive section (not shown), such as a motor provided in an upper portion of the first adjustment portion 332, is activated, the second adjustment portion 333 slides. The out-of-plane rotational position adjustment section 33 thus adjusts the out-of-plane-direction rotational position of the light modulator 141 (liquid crystal panel 1411) relative to the luminous flux incidence side end face of the cross dichroic prism 144.

The liquid crystal panel holding section 34 holds the light modulator 141 (liquid crystal panel 1411). As shown in FIG. 7, this liquid crystal panel holding section 34 includes a proximal member 342, a proximal portion 343, a pad 344, and a suction unit 345. The proximal member 342 is attached via four column members 341 projecting from the leading end of the second adjustment portion 333. The proximal portion 343 is firmly threaded onto the leading end side of this proximal member 342. The pad 344, housed so that the leading end portion thereof projects from this proximal portion 343, abuts the liquid crystal panel 1411 configuring the light modulator 141. The suction unit 345 vacuum-adheres the liquid crystal panel 1411 via this pad 344. The proximal member 342 and the proximal portion 343 of the liquid crystal panel holding section 34 are connected to the adjustment light source device 10 which supplies the position adjustment luminous flux to the liquid crystal panel 1411.

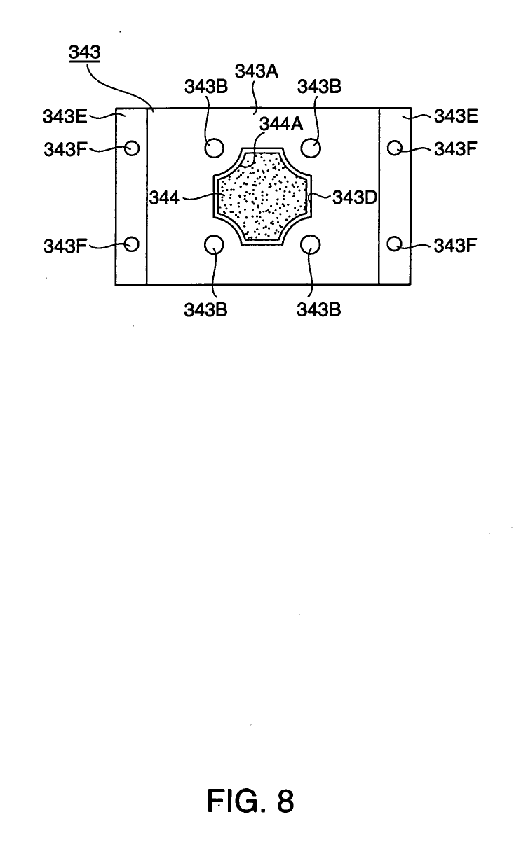

FIG. 8 is a front view of the proximal portion 343 of the liquid crystal panel holding section 34.

The proximal portion 343 is a hollow member whose planar, main central portion projects. The planar, main central portion of the rectangular end face of this projecting portion 343A is formed with adjustment light source holes 343B set in response to the corner portions of the image forming region of the liquid crystal panel 1411 and a hole 343D having a cross-like shape in plan view which, located between the adjustment light source holes 343B, is used to allow the pad 344 to protrude.

Four screw holes 343F are formed in a projecting portion 343E extending outward at the back of the proximal portion 343. Screws are inserted through these four screw holes 343F, thereby screwing the proximal portion 343 to the proximal member 342.

The pad 344, which is a porous elastic member, includes a body portion (not shown) which is housed in the proximal portion 343 and a cross portion 344A which projects a predetermined dimension from this body portion and which has the end face of this projecting portion formed into across-like shape having a dimension corresponding to the hole 343D. when such a pad 344 is attached to the proximal portion 343, the cross portion 344A of the pad 344 protrudes from the end face of the proximal portion 343. Therefore, the liquid crystal panel 1411 abuts only the cross portion 344A of the pad 344 without abutting the proximal portion 343.

Although not specifically shown, the vacuum adherence of the suction unit 345 causes the pad 344 to hold the liquid crystal panel 1411 via a specified air hose 345A.

2-1-2. Structure of Luminous Flux Detection Device

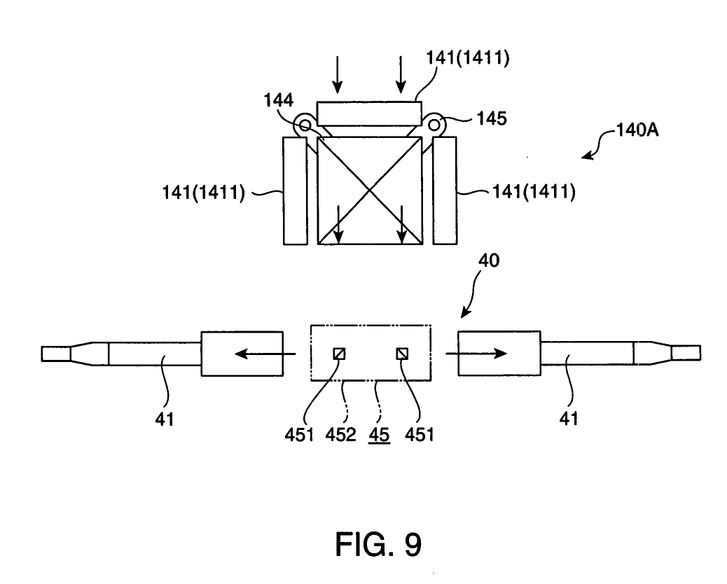

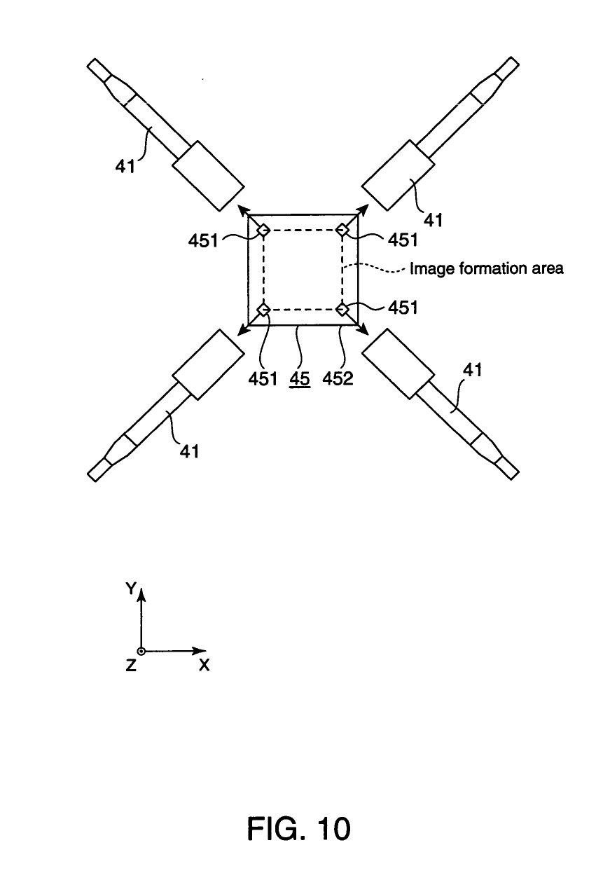

FIGS. 9 and 10 are views showing the structure of the luminous flux detection device 40. Specifically, FIG. 9 is a view of the optical device body 140A and the luminous flux detection device 40 as seen from above. FIG. 10 is a view of the optical device body 140A and the luminous flux detection device 40 as seen from the luminous flux emergence side of the cross dichroic prism 144.

As shown in FIG. 3 or 4, the luminous flux detection device 40, located downstream of the luminous flux emergence side end face of the cross dichroic prism 144 mounted on the mounting section 50, is supported on and fixed to the mounting section 50. As shown in FIG. 3, 4, 9, or 10, this luminous flux detection device 40 includes a CCD camera 41, a moving mechanism 43 (FIG. 3 or 4) configured so as to make this CCD camera 41 movable in three dimensions, and a light guide 45.

The CCD camera 41, which is an area sensor with a CCD (Charge Coupled Device) as an image pickup device, receives a position adjustment luminous flux emitted from the cross dichroic prism 144 and outputs it as an electric signal.

As shown in FIG. 9 or 10, four CCD cameras 41 are positioned around the light guide 45 via the moving mechanism 43. On this occasion, the CCD cameras 41 are positioned in response to the diagonal lines of the rectangular image forming region on the liquid crystal panel 1411. To detect a projected image with high accuracy, the CCD cameras 41 are adapted to be capable of freely adjusting zoom and focus by remote control.

Although not specifically shown, the moving mechanism 43 includes support columns vertically arranged on the mounting section 50, a plurality of shaft members provided on these support columns, a camera attachment portion provided on one shaft member, and the like. In this moving mechanism, as shown in FIG. 10, the CCD cameras 41 can be moved in an X-axis direction, a Y-axis direction, and a Z-axis direction by a drive section (not shown), such as a motor.

As shown in FIG. 9 or 10, the light guide 45 includes four beam splitters 451 disposed in response to the four corners of the rectangular image forming region of the liquid crystal panel 1411 and a holding cover 452 for holding the beam splitters 451 in position. The adjustment light source device 10 irradiates the liquid crystal panel 1411 with a luminous flux, and four corner luminous fluxes are emitted from the cross dichroic prism 144. The light guide 45 has the function of causing the beam splitters 451 to refract the four corner luminous fluxes at 90 degrees and of thereafter guiding them to the CCD cameras 41.

The holding cover 452 is provided with an opening for transmitting a luminous flux refracted outward. FIG. 9 shows the case in which a luminous flux irradiates the liquid crystal panel 1411 disposed at a position opposite the projection lens 160. According to such a light guide 45, the four corner luminous fluxes emitted from the cross dichroic prism 144 are directly detected by the CCD cameras 41 disposed in four directions without being projected onto the screen or the like (direct version type).

2-1-3. Structure of Mounting Section

As shown in FIG. 3, the mounting section 50 includes a base plate 51 disposed on the bottom plate 22, a leg 52 vertically set on this base plate 51, and a setting plate 53 which is set on top of this leg 52 and to which are attached the optical device body 140A, the luminous flux detection device 40, and the provisional fixing section 60.

2-1-4. Structure of Provisional Fixing Section

After the six-axis position adjustment devices 30 execute the position adjustment of the liquid crystal panels 1411, the provisional fixing section 60 emits a luminous flux in an ultraviolet region (hereafter described as an ultraviolet) to provisionally fix the light modulators 141 to the cross dichroic prism 144 via the light modulator supports 146. As shown in FIG. 3 or 4, this provisional fixing section 60 includes four first provisional fixing portions 61 and a second provisional fixing portion 62.

As shown in FIG. 3 or 4, when the support structural body 145 having the cross dichroic prism 144 fixed thereto is supported on the mounting section 50, the four first provisional fixing portions 61 are arranged opposite four corners, in plan view, of the cross dichroic prism 144. Each first provisional fixing portion 61 thus emits the ultraviolet to cure a UV cure adhesive between the first support 1461 and the second support 1462, thus provisionally fixing the second support 1462 to the first support 1461. Since the four first fixing portions 61 have the same configuration, only one first provisional fixing portion will hereafter be described. As shown in FIG. 3 or 4, the first provisional fixing portion 61 includes two LED modules 611 and a support member 612.

The two LED modules 611 execute lighting under the control of the adjustment control device to emit luminous fluxes toward the apertures 1461B1 formed in the first support 1461. These LED modules 611 each has arrayed and formed on a Si substrate a plurality of LED elements which are solid luminous elements. The LED elements configuring the LED modules 611 are configured to emit an ultraviolet of 400 nm or less. In this embodiment, the aforementioned LED elements emit an ultraviolet of 365 nm. Besides, the two LED modules 611 are formed with a light source drive circuit which applies a drive voltage to each aforementioned LED element in response to a drive signal from the adjustment control device.

The support member 612 supports the two LED modules 611 and can move these two LED modules 611 in a direction toward and away from the cross dichroic prism 144. This support member 612, having a generally L-shaped configuration in plan view, is configured as follows. That is, the support member 612 is connected to a rail 53A (FIG. 4) which, formed on the setting plate 53 of the mounting section 50, extends in a direction toward and away from the four corner portions in plan view of the cross dichroic prism 144. The support member 612 can slide along the rail 53A to which it is connected in such a manner that the vertical portion of the L-shape supports the two LED modules 611 and that the horizontal portion of the L-shape emits luminous fluxes, emitted from the two LED modules 611, toward the four corners, in plan view, of the cross dichroic prism 144. The support member 612 is slid along the rail 53A by a drive section (not shown) such as a motor.

As shown in FIG. 3 or 4, when the support structural body 145 having the cross dichroic prism 144 fixed thereto is supported on the mounting section 50, the second provisional fixing portion 62 is disposed above the cross dichroic prism 144. The second provisional fixing portion 62 emits the ultraviolet to cure a UV cure adhesive between the cross dichroic prism 144 and the first support 1461, thus provisionally fixing the first support 1461 to the cross dichroic prism 144. As shown in FIG. 3 or 4, this second provisional fixing portion 62 includes four LED modules 621 and a support member 622.

The four LED modules 621, having the same configuration as the aforementioned LED modules 611, execute lighting under the control of the adjustment control device to emit luminous fluxes toward the four corners, in plan view, of the cross dichroic prism 144, from above the cross dichroic prism 144.

The support member 622 supports the four LED modules 621 so that the four LED modules 621 are opposed, above the cross dichroic prism 144, to the four corners, in plan view, of the cross dichroic prism 144. As shown in FIG. 3 or 4, this support member 622 includes a proximal portion 6221, a rotating portion 6222, a moving portion 6223, and a support plate 6224.

The proximal portion 6221, vertically set on the setting plate 53 of the mounting section 50, consists of a rod-like member extending in a Y-axis direction.

The rotating portion 6222 is configured of a rod-like member one end section of which is connected to the proximal portion 6221 so as to be rotatable along an XY plane, and the other end section of which extends along an XY plane.

The moving portion 6223 is configured of a rod-like member which is connected to the other end section of the rotating portion 6222 so as to be movable in a Y-axis direction.

The support plate 6224 is attached to the tip portion of the movable portion 6223 and supports the four LED modules 621 in position.

The rotating portion 6222 is rotated relative to the proximal portion 6221 by a drive section (not shown) such as a motor to position the support plate 6224 at an irradiation position (position at which the support plate 6224 is positioned on the upper side of the cross dichroic prism 144 and the four LED modules 621 are opposed to the four corner positions in plan view of the cross dichroic prism 144) and at an non-irradiation position (position at which the support plate 6224 is deviated in plan view from the upper side of the cross dichroic prism 144). The moving portion 6223 is moved in a Y-axis direction relative to the rotating portion 6222 by a drive section (not shown) such as a motor.

2-1-5. Structure of Adjustment Control Device

FIG. 11 is a block diagram showing the structure of control exerted by the adjustment control device 70.

The adjustment control device 70, configured of a computer including a CPU (Central Processing Unit) and a hard disc, executes various programs to control the entire adjustment apparatus 2. As shown in FIG. 11, this adjustment control device 70 includes an operation section 71, a display section 72, and a control section 73.

The operation section 71 has various operation buttons (not shown) which is configured to receive input from, for example, a keyboard and a mouse. This entry operation to the operation buttons is executed, thereby operating the adjustment control device 70 as appropriate and executing the setting of the operational content of the adjustment control device, for example, with respect to information displayed on the display section 72. The operation section 71 is configured to receive input from an operator, thereby sending a predetermined operational signal from this operation section 71 to the control section 73 as appropriate.

This operation section 71 can also be configured such that various conditions are set and input by the entry operation using not only the operation buttons but, for example, a touch panel or a sound.

The display section 72 is controlled by the control section 73 to display a predetermined image. For example, the display section 72 displays an image processed by the control section 73, or when the operation section 71 is operated for entry to set, enter, or update information stored in a to-be-described memory, as appropriate, displays in-memory data outputted from the control section 73. This display section 72 uses, for example, a liquid crystal, an organic EL (Electroluminescence), a PDP (Plasma Display Panel), or a CRT (Cathode-Ray Tube).

The control section 73, configured as a program developed on an OS (Operating System) which controls the CPU, executes a predetermined program in response to the input of the operational signal from the operation section 71 to control the driving of the entire adjustment apparatus 2. As shown in FIG. 11, this control section 73 includes an image download section 731, an image processing section 732, a drive control section 733, and the memory 734.

The image download section 731, configured of a video capture board for example, receives a signal transmitted from the CCD camera of the luminous detection device 40, converts the received signal to an image signal, and sends the image signal to the image processing section 732.

The image processing section 732 reads the image signal transmitted from the image download section 731, executes image processing based on the read image signal, and determines the optimal position of the liquid crystal panel 1411 based on the processed result. The image processing section 732 then sends a predetermined signal based on the determined optimal position to the drive control section 733.

Based on a predetermined control program or the signal transmitted from the image processing section 732, the drive control section 733 sends a control signal to the drive section 70A, thus causing the drive section 70A to drive the six-axis position adjustment device 30, the luminous flux detection device 40, the provisional fixing section 60, and the adjustment light source device 10. As described above, the drive section 70A is configured of a motor, the light source drive circuit, and the like.

The memory 734 stores the predetermined control program, model data, and optimal position data outputted from the image processing section 732.

As the model data, an example is the following data.

For example, data may be used regarding a reference pattern image, obtained from a master optical device (not shown) which serves as the reference of the optical device body 140A provided as a manufacturing target, and the reference position of the CCD camera 41.

In addition, for example, initial position data (data on a coordinate value) of the light modulator 141 (liquid crystal panel 1411) may be used, to configure the optical device body 140A provided as a manufacturing target.

Furthermore, for example, data on the irradiation position (coordinate value) and the non-irradiation position (coordinate value), of the support plate 6224 may be used, which correspond to the model of the optical device body 140A provided as a manufacturing target, as well as data on the irradiation positions (coordinate values) of the LED modules 611 and 621.

2-2. Structure of Permanent Fixing Apparatus

The permanent fixing apparatus 3 irradiates with an ultraviolet the optical device body 140A in which the aforementioned adjustment apparatus 2 has executed the position adjustment and provisional fixing of the liquid crystal panels 1411 with respect to the cross dichroic prism 144.

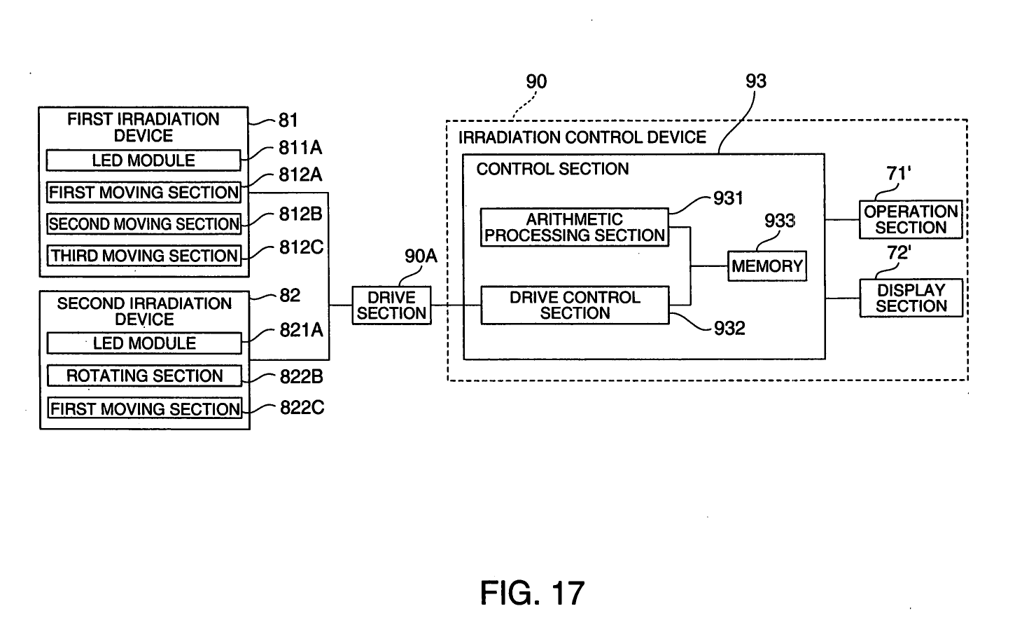

As shown in FIG. 5 or 6, this permanent fixing apparatus 3 includes a UV light-shielding cover 20′ and a mounting section 50′, which are similar to the aforementioned U light-shielding cover 20 and mounting section 50, four first irradiation devices 81, a second Irradiation device 82 and an irradiation control device 90 (see FIG. 17).

2-2-1. Structure of First Irradiation Device

As shown in FIG. 5 or 6, when the optical device body 140A is supported on the mounting section 50′, the four first irradiation devices 81 are disposed opposite the luminous flux incidence and emergence side end faces of the cross dichroic prism 144. The first irradiation devices 81 emit an ultraviolet to thereby cure a UV cure adhesive between the first support 1461 and the second support 1462, thus permanently fixing the second support 1462 to the first support 1461. Hereafter, for brevity of description, out of the four first irradiation devices 81, the two first irradiation devices opposed to the luminous flux emergence side end face of the cross dichroic prism 144 and the luminous flux incidence side end face opposite this luminous flux emergence side end face, respectively, will be described as 81A, and the other two first irradiation devices will be described as 81B.

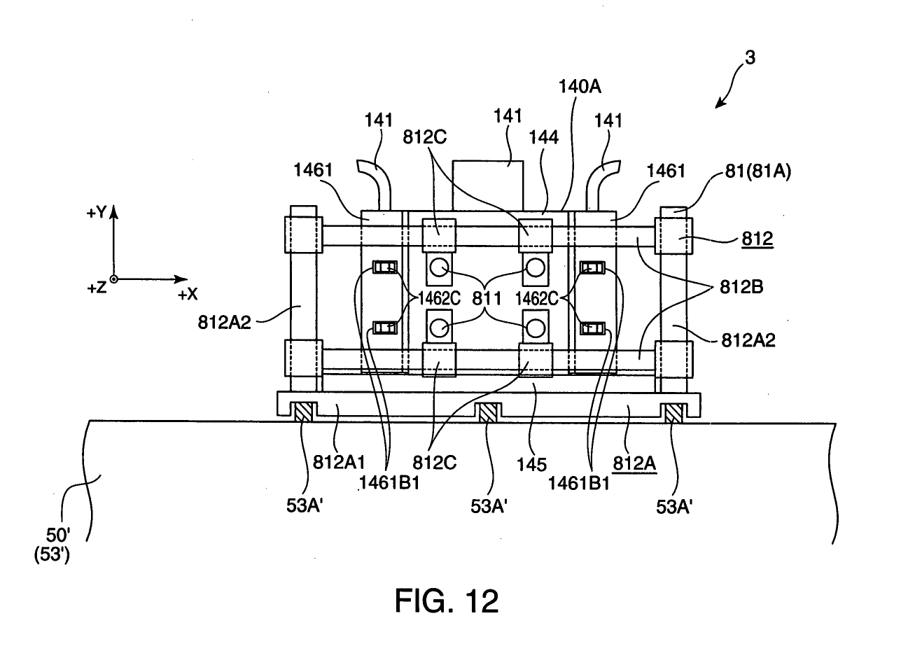

FIG. 12 is a view showing the structure of the first irradiation device 81A. In FIG. 12, as in FIGS. 5 and 6, the optical axis of a luminous flux emitted from the optical device body 140A is indicated by a Z-axis, and two axes perpendicular to the Z-axis are indicated by an X-axis and a Y-axis.

As shown in FIG. 12, the first irradiation device 81A includes four irradiation device bodies 811 and a moving mechanism 812.

Under the control of the irradiation control device, the four irradiation device bodies 811 emit ultraviolets converging on a predetermined position. Since the four irradiation device bodies 811 have the same configuration, the configuration of only one irradiation device body 811 will be described below.

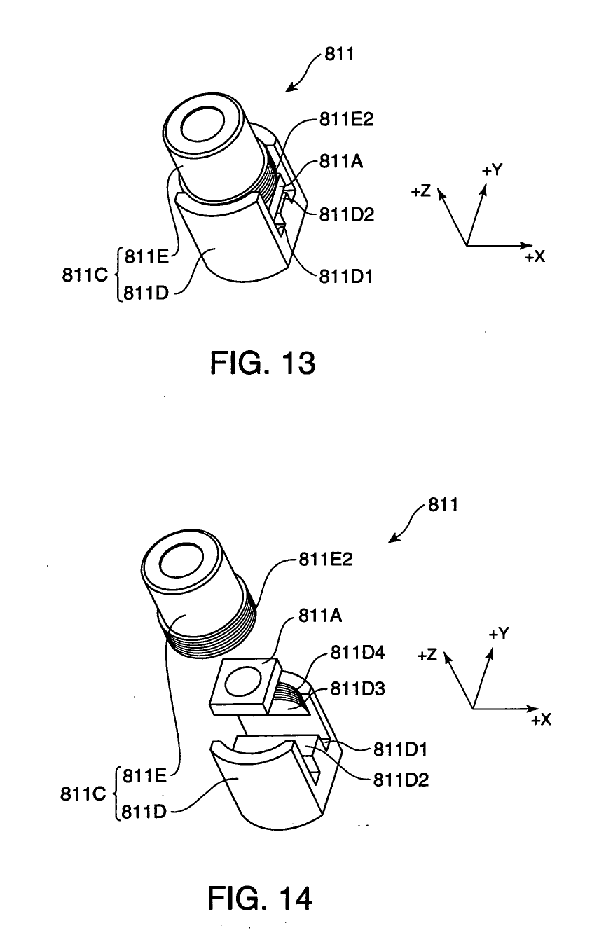

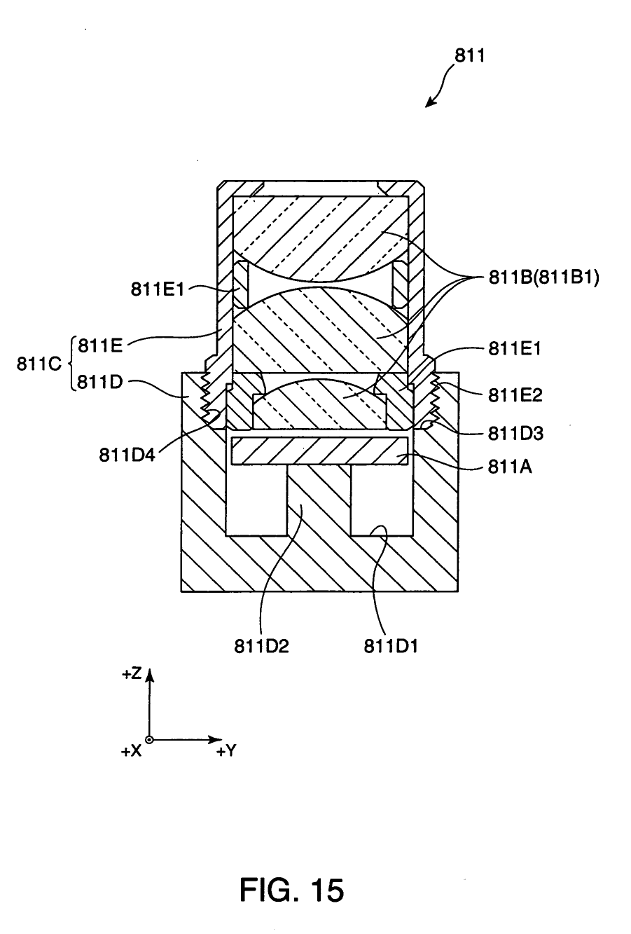

FIGS. 13 to 15 are views showing the structure of the irradiation device body 811. Specifically, FIG. 13 is a perspective view of the irradiation device body 811, FIG. 14 is an exploded perspective view of the irradiation device body 811, and FIG. 15 is a sectional view of the irradiation device body 811. In FIGS. 13 to 15, the direction of the emission of a luminous flux is indicated by a Z-axis, and two axes perpendicular to this Z-axis are indicated by an X-axis and a Y-axis.

As shown in FIGS. 13 to 15, the irradiation device body 811 includes an LED module 811A, a collector 811B (FIG. 15), and a fixing member 811C.

The LED module 811A, having the same configuration as the aforementioned LED modules 611 and 621 of the adjustment apparatus 2, executes lighting under the control of the irradiation control device to emit an ultraviolet.

As shown in FIG. 15, the collector 811B, configured of a plurality of (in this embodiment, three) collective lenses 811B1, focuses ultraviolets, irradiated from the LED module 811A, on a predetermined position. These collective lenses 811B1 are preferably formed of a material which absorbs less ultraviolet. For example, the material preferably used is quartz.

The fixing member 811C is a member which holds and secures therein the LED module 811A and the collector 811B. As shown in FIGS. 13 to 15, this fixing member 811C includes a first fixing member 811D and a second fixing member 811E.

The first fixing member 811D is configured of a metal material such as aluminum and, as shown in FIGS. 13 to 15, has a generally cylindrical shape.

As shown in FIGS. 13 to 15, this first fixing member 811D is formed with a recess 811Da which, penetrating across the first fixing member 811D in an X-direction, has a rectangular shape in plan view, extending from the +Z-axis-direction end face to the −Z-axis side of the approximately central Z-axis-direction portion.

As shown in FIGS. 13 to 15, formed on the bottom surface of this recess 811D1 is an LED support 811D2 which, projecting in a +Z-axis direction, mounts and supports the LED module 811A with its top portion. The LED module 811A is mounted and fixed to this LED support 811D2 and is thereby heat-transferably connected to the fixing member 811C.

Additionally, as shown in FIG. 14 to 15, the first fixing member 811D is formed with a recess 811D3 having a circular shape in plan view corresponding to the outside shape of the second fixing member 811E, extending from the +Z-axis-direction end face to the +Z-axis side of the approximately central Z-axis-direction portion. As shown in FIG. 14 or 15, an internal thread groove 811D4 is formed on the inner surface of this recess 811D3.

Similar to the first fixing member 811D, the second fixing member 811E is configured of a metal material such as aluminum and, as shown in FIGS. 13 to 15, has a generally hollow cylindrical shape. The second fixing member 811E holds and secures therein the plurality of collective lenses 811B1 via a spacer 811E1.

As shown in FIGS. 13 to 15, an external thread groove 811E2 is formed on the outer surface of this second fixing member 811E on the −Z-axis-direction side. The external thread groove 811E2 of the second fixing member 811E is threaded into the internal thread groove 811D4 of the first fixing member 811D, thereby fixing the second fixing member 811E to the first fixing member 811D. In this state, the −Z-axis-direction end of the second fixing member 811E abuts the bottom surface of the recess 811D3 of the first fixing member 811D and, as shown in FIG. 13, a gap is formed between the −Z-axis-direction end of the second fixing member 811E and the recess 811D3 of the first fixing member 811D. This provides a configuration such that heat will not stay inside the fixing member 811C.

The fixing member 811C described above has its surface subjected to erosion-resistant treatment, for example, black almite treatment or chromate treatment, thus preventing the inner surface of the fixing member 811C from being dispersed by the irradiation of an ultraviolet emitted from the LED module 811A.

As shown in FIG. 12, the moving mechanism 812 supports the four irradiation device bodies 811 and renders the four irradiation device bodies 811 movable in X-axis, Y-axis, and Z-axis directions. As shown in FIG. 12, this moving mechanism 812 includes a first moving section 812A, two second moving sections 812B, and four third moving sections 182C.

As shown in FIG. 12, the first moving section 812A, having an angular U-shape in plan view, is configured of a base portion 812A1 extending in the X-axis direction and extension portions 812A2 extending in the Y-axis direction from both ends of the base portion 812A1.

The base portion 812A1 is connected to three rails 53A′ (FIG. 6 or 12) which, formed on a setting plate 53′ of the mounting section 50′, extends in the Z-axis direction. The first moving section 812A is slid along the rail 53A′ by the drive section (not shown) such as a motor and thus moves in a direction (a first axial direction, a Z-axis direction) toward and away from the cross dichroic prism 144.

As shown in FIG. 12, the two second moving sections 812B are each configured of a plate-like member extending in the Y-axis direction, and both end portions of each plate-like member are connected to the extension portions 812A2 of the first moving section 812A. The two second moving sections 812B are slid along the extension portion 812A2 and moved in the Y-axis direction (second axial direction) by a drive section (not shown) such as a motor.

As shown in FIG. 12, the four third moving sections 812C are each configured of a plate-like member extending in the Y-axis direction, and one end side of each plate-like member is connected to the respective second moving section 812B. Out of the four third moving sections 812C, two third moving sections 812C are connected to the second moving section 812B on the +Y-axis-direction side, and the other two third moving sections 812C are connected to the second moving section 812B on the −Y-axis-direction side. In addition, the four third moving sections 812C are connected to the respective second moving sections 812B in such a manner that the opposite ends of the two third moving sections 812C connected to the second moving section 812B on the +Y-axis-direction side are in proximity to the opposite ends of the two third moving sections 812C connected to the second moving section 812B on the −Y-axis-direction side.

Besides, as shown in FIG. 12, the four third moving sections 812C support the irradiation device body 811 on their opposite end sides so as to enable the irradiation device bodies 811 to emit ultraviolets in the Z-axis direction.

The four third moving sections 812C are slid along the second moving sections 812B and moved in the X-axis direction (third axial direction) by a drive section (not shown) such as a motor.

The irradiation device bodies 811 supported by the four third moving sections 812C are thus moved in the Z-axis-direction (first axial direction), the Y-axis direction (second axial direction), and the X-axis direction (third axial direction) by the moving mechanism 812 as described above.

The first irradiation devices 81A each emit an ultraviolet toward one of four side end faces of each of the first supports 1461 provisionally fixed to the two opposing luminous flux incidence side end faces out of the luminous flux incidence side end faces of the cross dichroic prism 144.

Additionally, the first irradiation devices 81B each emit an ultraviolet toward both side end faces of the first support 1461 provisionally fixed to the luminous flux incidence side end face opposite the luminous flux emergence side end face, out of the luminous flux incidence side end faces of the cross dichroic prism 144. The first irradiation devices 81B each have the configuration in which the one third moving section 812C (including the irradiation device body 811) connected to the upper second moving section 812B and the one third moving section 812C (including the irradiation device body 811) connected to the lower second moving section 812B omitted from the first irradiation device 81A configure the first irradiation devices 81B. That is, as shown in FIGS. 5 and 6, each first irradiation device 81B consists of the two irradiation device bodies 811 and the moving mechanism 812 which includes the first moving section 812A, the two second moving sections 812B, and the two third moving sections 812C.

2-2-2. Structure of Second Irradiation Device

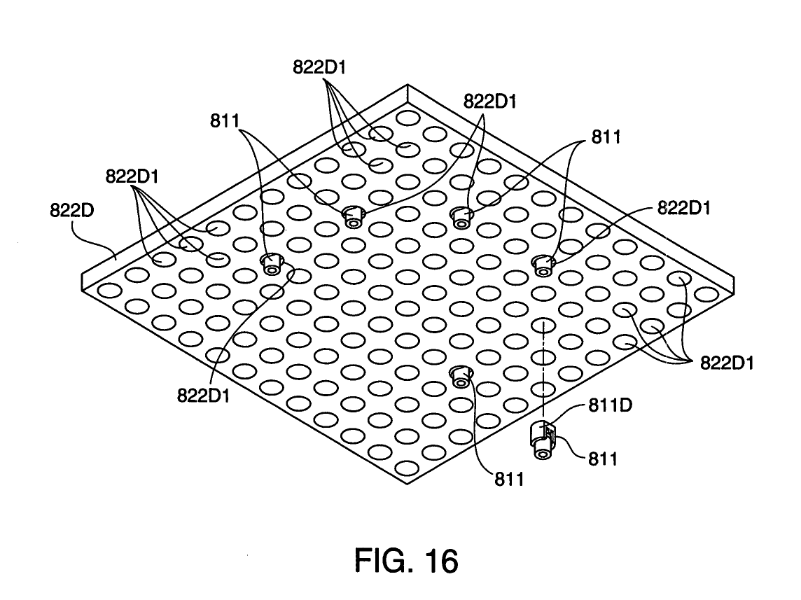

As shown in FIG. 5 or 6, when the optical device body 140A is supported on the mounting section 50′, the second irradiation device 82 is positioned so as to be able to emit an ultraviolet from above the cross dichroic prism 144. The second irradiation device 82 emits the ultraviolet to cure a UV cure adhesive between the cross dichroic prism 144 and the first support 1461, thus permanently fixing the first support 1461 to the cross dichroic prism 144. As shown in FIG. 5 or 6, this second irradiation device 82 includes six irradiation device bodies 821 (see FIG. 16) and a moving mechanism 822.

The six irradiation device bodies 821, having the same configuration as the aforementioned irradiation device bodies 811, each include an LED module 811A, a collector 811B, and a fixing member 811C.

The moving mechanism 822 supports the six irradiation device bodies 821 and moves the six irradiation device bodies 821 in a direction toward and away from the cross dichroic prism 144. As shown in FIG. 5 or 6, this moving mechanism 822 includes a base portion 822A, a rotating portion 822B, a first moving portion 822C, and a support plate 822D.

The base portion 822A, vertically set on a setting plate 53′ of the mounting section 50′, consists of a rod-like member extending in a Y-axis direction.

The rotating portion 822B consists of a rod-like member, one end section of which is connected to the base portion 822A so as to be rotatable along an XZ plane, and the other end section of which extends along an XZ plane.

The first moving portion 822C consists of a rod-like member which is connected to the other end section of the rotating portion 822B so as to be movable in a Y-axis direction.

The rotating portion 822B is rotated relative to the base portion 822A by a drive section (not shown) such as a motor to position the support plate 822D at an irradiation position (position at which the support plate 822D is opposed to the upper side of the cross dichroic prism 144) and at a non-irradiation position (position at which the support plate 822D is deviated in plan view from the upper side of the cross dichroic prism 144).

In addition, the first moving portion 822C is slid along the base portion 822A and moved in a direction (Y-axis direction, a first axial direction) toward and away from the cross dichroic prism 144 by a drive section (not shown) such as a motor.

FIG. 16 is a perspective view showing the structure of the support plate 822D. Specifically, FIG. 16 is a perspective view of the support plate 822D as seen from a −Y-axis direction.

The support plate 822D, which is a plate body attached to the other end of the first moving portion 822C and extending along an XZ plane, supports the six irradiation device bodies 821.

As shown in FIG. 16, the support plate 822D is formed with through-holes 822D1 which, penetrating through the front and back thereof, act as a plurality of recesses corresponding to the outer peripheral shape of the first fixing members 811D of the irradiation device bodies 821. The first fixing members 811D of the irradiation device bodies 821 are inserted into the through-holes 822D1, and the irradiation device bodies 821 are thereby positioned on the support plate 822D in such a manner that ultraviolets emitted from the irradiation device bodies 821 can be emitted in a −Y-axis direction.

As shown in FIG. 16, these through-holes 822D1 are formed to be arrayed in matrix fashion at a predetermined pitch on the support plate 822D. In this embodiment, the through-holes 822D1 are formed at the pitch which is the same as the outer peripheral dimension of the first fixing members 811D or in the order of 0.5 mm greater than the outer peripheral dimension thereof.

2-2-3. Structure of Irradiation Control Device

FIG. 17 is a block diagram showing the structure of control exerted by the irradiation control device 90.

Similar to the adjustment control device 70, the irradiation control device 90, consisting of a computer including a CPU and a hard disc, executes various programs to control the entire permanent fixing apparatus 3. As shown in FIG. 17, this irradiation control device 90 includes an operation section 71′ and a display section, which are the same as the aforementioned operation section 71 and display secton 72, and a control section 93.

Similar to the aforementioned control section 73 of the adjustment control device 70, the control section 93, configured as a program developed on an OS (Operating System) which controls the CPU, executes a processing program in response to the input of an operational signal from the operation section 71′ to control the driving of the entire permanent fixing apparatus 3. As shown in FIG. 17, this control section 93 includes an arithmetic processing section 931, a drive control section 932, and a memory 933.

The arithmetic processing section 931 reads model position (coordinate value) of the support plate 822D, which corresponds to the model of the optical device body 140A provided as a manufacturing target, and the irradiation positions (coordinate values) of the irradiation device bodies 811 and 821, and transmits to the drive control section 932 a predetermined signal corresponding to each of these irradiation positions.

In response to the signal transmitted from the arithmetic processing section 931, the drive control section 932 transmits a predetermined control signal to the drive section 90A to drive the first irradiation device 81 and the second irradiation device 82, thus positioning the support plate 822D at its irradiation position and also positioning the irradiation device bodies 811 and 821 at their respective irradiation positions. Additionally, in accordance with a predetermined program stored in the memory 933, the drive control section 932 transmits a predetermined control signal to the drive section 90A to drive the first irradiation device 81 and the second irradiation device 82, thus emitting ultraviolets from the irradiation device bodies 811 and 821. As described above, the drive section 90A is configured of the motor, the light source drive circuit, and the like.

The memory 933 stores the predetermined program and the model data corresponding to the model of a projector.

As the model data, for example, data on the irradiation position (coordinate value) and the non-irradiation position (coordinate value), of the support plate 6224 may be used, which correspond to the model of the optical device body 140A provided as a manufacturing target, as well as data on the irradiation positions (coordinate values) of the irradiation device bodies 811 and 821.

3. Optical Device Body Manufacturing Method

The method of manufacturing the optical device body 140A by the aforementioned manufacturing apparatus 1 will now be described with reference to the drawings. Hereafter, in the optical device body 140A and the master optical device, out of the three luminous flux incidence side end faces of the cross dichroic prism 144, a G color light modulator 141G will be located on the luminous flux incidence side end face farthest from the projection lens 160, and R and B color light modulators 141R and 141B will be located on the other two luminous flux incidence side end faces.

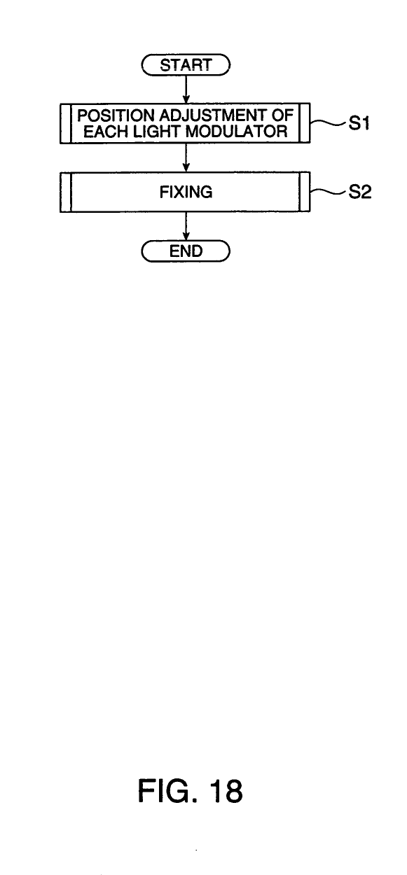

FIG. 18 is a flowchart illustrating the method of manufacturing the optical device body 140A.

As shown in FIG. 18, the position adjustment (step S1) of the light modulators using the aforementioned adjustment apparatus 2 and the fixing (step S2) of the light modulators 141 to the cross dichroic prism 144 using the aforementioned permanent fixing apparatus 3 are executed in manufacturing the optical device body 140A.

The position adjustment method (step S1) and the fixing method (step S2) will hereafter be described in sequence.

3-1. Position Adjustment Method

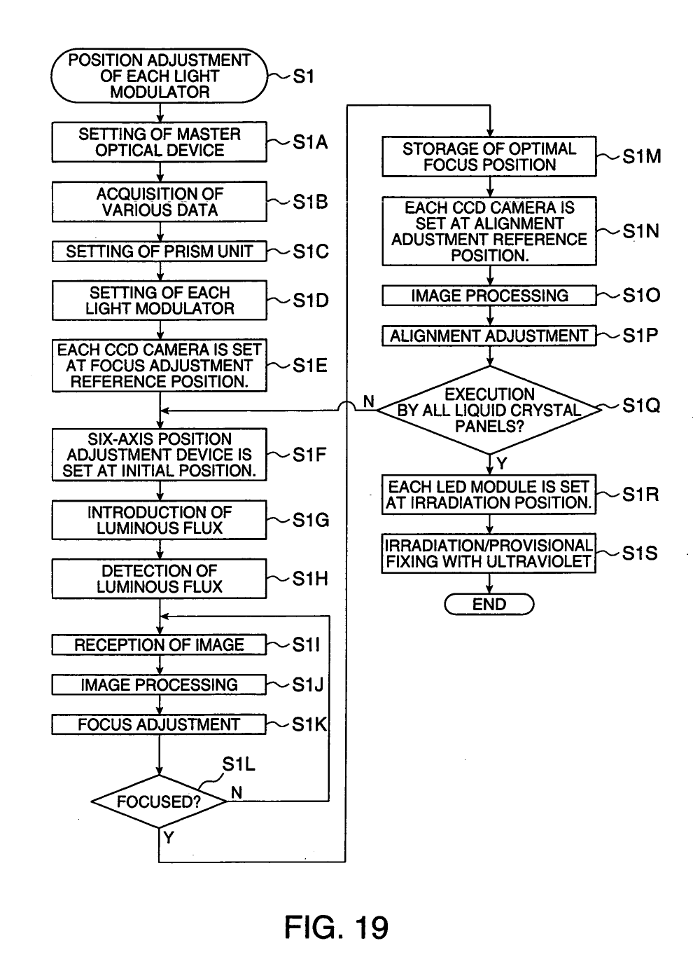

FIG. 19 is a flowchart illustrating the method of adjusting the position of each light modulator 141.

First, before the position adjustment of the light modulators 141 is executed, a reference pattern for image processing which corresponds to the model of a projector and the reference position of the CCD camera 41 are pre-acquired in advance (steps S1A and S1B).

Specifically, the operator sets, on the mounting section 50 of the adjustment apparatus 2, the master optical device with the focus position and the alignment position pre-adjusted, and the light guide 45 with the arrangement positions of the beam splitters 451 set in response to the size of the image forming region of this master optical device (step S1A). The master optical device, provided in response to the model, is provided by integrating a reference support structural body having a design outside dimension without a manufacturing error, a reference cross dichroic prism, a reference light modulator support, and three reference light modulators (reference liquid crystal panels).

Next, the operator operates the operation section 71 of the adjustment control device 70 to invoke a predetermined program of intent to execute the operation of registering model data corresponding to the model of a projector. The control section 73 of the adjustment control device 70 reads the program stored in the memory 734 to execute the following steps.

First, the control section 73 activates the adjustment light source device 10 to introduce a position adjustment luminous flux (G color light) from the leading end of the six-axis position adjustment device 30 into a G color light reference liquid crystal panel of the master optical device. Then, the luminous flux emitted from the master optical device is directly received by the CCD camera 41 via the beam splitter 451. On this occasion, the control section 73 activates the moving mechanism 43 to move each CCD camera 41 to a position at which the luminous flux can be reliably received (step S1B).

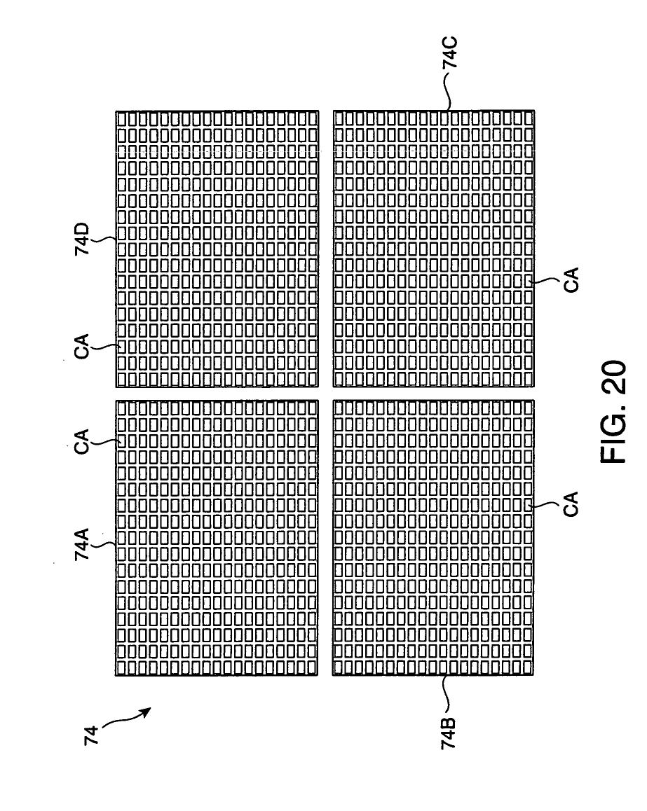

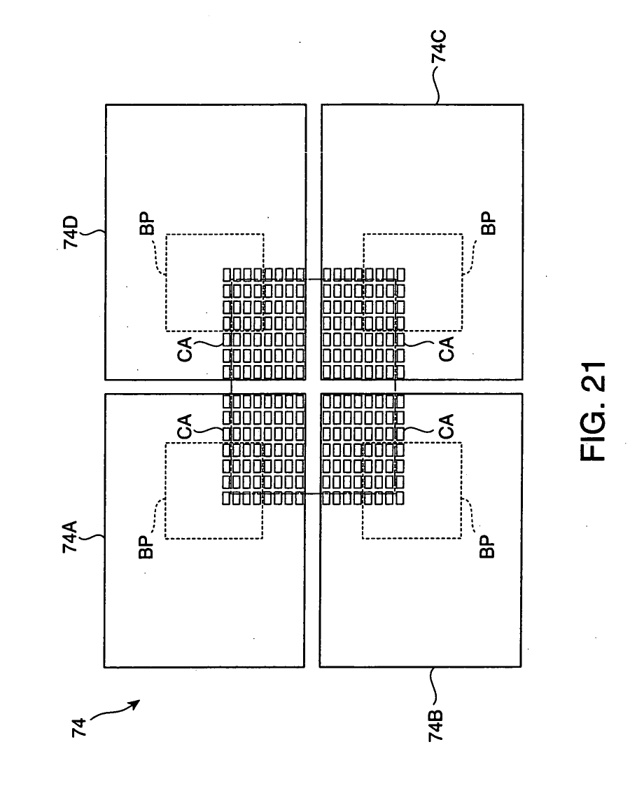

FIGS. 20 and 21 are views showing an example of an image taken by each CCD camera 41.

As an image 74 taken by four CCD cameras 41, for example, as shown in FIG. 20 or 21, is configured of four images 74A, 74B, 74C, and 74D, wherein a plurality of pixel regions CA corresponding to four corners of the reference liquid crystal panel are displayed. As shown in FIG. 20, the pixel regions CA are moved in a diagonally inward direction from end positions corresponding to the four corners of the reference liquid crystal panel, and the positions at which only the pixel regions CA are displayed in the images 74A to 74D thus become reference positions for the focus adjustment of the CCD cameras 41 (hereafter described as focus adjustment reference positions). Besides, as shown in FIG. 21, generally square regions, in which the end positions corresponding to the four corners of the reference liquid crystal panel are displayed and the pixel regions CA and regions outside these pixel regions CA are set at a predetermined ratio, become reference patterns BP for the alignment adjustment of the liquid crystal panels 1411. Additionally, the positions of the CCD cameras 41 obtained at this time become reference positions for the alignment adjustment corresponding to the model (hereafter described as alignment adjustment reference positions). The control section 73 thus stores in the memory 734 the reference patterns BP and the reference positions (the focus adjustment reference positions and the alignment adjustment reference positions) of the CCD cameras 41 as the model data corresponding to the model.

The above steps S1A and S1B are pre-performed in response to a plurality of models, and the reference patterns BP for each model and the reference positions (the focus adjustment reference positions and the alignment adjustment reference positions) of the CCD cameras 41 are registered as the model data.

The position adjustment Of the light modulators 141 is executed following the above steps S1A and S1B.

First, the operator removes the master optical device placed on the mounting section 50 and sets on the mounting section 50 a prism unit obtained by integrating the cross dichroic prism 144 and the support structural body 145 (step S1C).

After step S1C, the operator executes the operation in which a panel unit, obtained by integrating each light modulator support 146 and each light modulator 141, is attached and held by the liquid panel holding section 34 of each six-axis position adjustment device 30 (step S1D).

Specifically, first, the second support 1462 and the light modulator 141 are connected by the screws 148 via the fixing holes 1462A2 of the second support 1462 and the fixing holes 1412A.

Thereafter, the second support 1462 having connected thereto the light modulator 141 is inserted between the projecting portions 1461B of the first support 1461, and the raised portions 1462C of the second support 1462 are freely fitted in the apertures 1461B1 of the first support 1461.

In the panel unit obtained by integrating the light modulator 141, the first support 1461, and the second support 1462 as described above, the UV cure adhesive is applied between the apertures 1461B1 and the raised portions 1461C, and to the luminous flux emergence side end face of the first support 1461.

Then, with the UV cure adhesive uncured, the luminous flux incidence side end face of the liquid crystal panel configuring the panel unit is attached and held by the liquid crystal panel holding section 34 of the six-axis position adjustment device 30.

After step S1D, the operator operates the operation section 71 of the adjustment control device 70 to execute an entry operation of intent to execute the position adjustment of the light modulators 141. The control section 73 reads the program stored in the memory 734 to, start the position adjustment of the light modulators 141, as described below.

First, based on the model data stored in the memory 734, the drive control section 733 transmits a predetermined control signal to the drive section 70A to drive the moving mechanism 43, thus setting the four CCD cameras 41 at the focus adjustment reference positions (step S1E).

After step S1E, the drive control section 733 reads the design coordinate value (initial position data) of the G color light modulator 141G, which is included in the model data stored in the memory, to transmit the predetermined control signal to the drive section 70A. The drive control section 733 thus sets the plan position adjustment section 31, the in-plane rotational position adjustment section 32, and the out-of-plane rotational position adjustment section 33, of the six-axis position adjustment device 30, at their initial positions (step S1F). In this state, the luminous flux emergence side end face of the first support 1461, having applied thereto the UV cure adhesive, and the luminous flux incidence side end face of the cross dichroic prism 144 are in abutment, and the G color light modulator 141G is set at a design reference position relative to the cross dichroic prism 144.

After step S1F, the drive control section 733 transmits a predetermined control signal to the drive section 70A to drive the adjustment light source device 10, thus introducing the position adjustment luminous flux (G color light) into the G color light modulator 141G (liquid crystal panel 1411) (step S1G).

Then, the control section 73 causes the CCD cameras 41 of the luminous detection device 40 to detect the luminous flux (G color light) emitted from the luminous flux emergence side end face of the cross dichroic prism 144 (step S1H).

After step S1H, the image download section 731 of the control section 73 inputs signals transmitted from the CCD cameras 41 and converts the inputted signals into image signals (step S1I). The converted image signals are then transmitted to the image processing section 732.

The image processing section 732 reads the image signals transmitted from the image download section 731 and, as in FIG. 20 for example, calculates a specific index value (edge strength) of the outer peripheral portion from the image 74 in the four corner portions of the liquid crystal panel 1411 (step S1J). Then, the image processing section 732 stores the calculated index value in the memory 734 and transmits a predetermined signal to the drive control section 733.

Based on the signal transmitted from the image processing section 732, the drive control section 733 transmits a predetermined signal to the drive section 70A to drive the six-axis position adjustment device 30. The drive control section 733 thus executes the focus adjustment (adjustment in a direction toward and away from the cross dichroic prism 144) of the G color light modulator 141G (liquid crystal panel 1411) (step S1K).

The image processing section 732, in step S1K, executes the focus adjustment of the G color light modulator 141G (liquid crystal panel 1411) to determine whether or not the calculated index values of the four corners become generally equal to one another and also reach their maximum values, i.e., whether the G color light modulator 141G is focused or not (step S1L). If it is determined that the G color light modulator 141G is not focused, steps S1I to S1K are repeatedly executed.

Conversely, if the image processing section 732 determines that the G color light modulator 141G (liquid crystal panel 1411) is focused, the Focus position (optimal focus position) of the G color light modulator 141G positioned in its focused state is stored in the memory 734 (step S1M).

After step S1M, based on the model data stored in the memory 734, the drive control section 733 transmits a predetermined control signal to the drive section 70A to drive the moving mechanism 43, thus setting the four CCD cameras 42 at their alignment adjustment reference positions (step S1N)

After step S1N, the image processing section 732 reads the reference pattern of the light modulator 141 stored in the memory 734. The image processing section 732 then compares this reference pattern image with the detection pattern image in the four corners of the liquid crystal panel 1411 positioned in its focused state, thus calculating the amount of deviation of the detection pattern image from the reference pattern image (step S10). The image processing section 732 then transmits a predetermined signal based on this deviation to the drive control section 733.

Based on the signal from the image processing section 732, the drive control section 733 transmits a predetermined control signal to the drive section 70A to drive the six-axis position adjustment device 30. The drive control section 733 thus executes the alignment adjustment (plan position, in-plane rotational position, and out-of-plane rotational position) of the G color light modulator 141G (liquid crystal panel 1411) (step S1P). The liquid crystal panel 1411 is then set at its optimal alignment position.

After step S1P, the aforementioned steps S1F to S1P are sequentially executed on the R color light modulator 141R and the B color light modulator 141B (step S1Q).

To execute steps S1G to S1P on the R color light modulator 141R and the B color light modulator 141B, in step S1F, the optimal focus position stored in the memory 734 in step S1M is read, and the six-axis position adjustment device 30 is then set at this optimal focus position. By so doing, the position adjustment of the R color light modulator 141R and the B color light modulator 141B can be performed from the state in which the mutual positions of the light modulators 141 are approximately aligned with one another. This makes it possible to accurately and smoothly execute the position adjustment of the light modulators. That is, to execute the aforementioned steps S1F to S1P on the R color light modulator 141R and the B color light modulator 141B, step S1M can be omitted.

Besides, to execute the aforementioned steps S1F to S1P on the R color light modulator 141R and the B color light modulator 141B, in step S1G, the drive control section 733 transmits a predetermined control signal to the drive section 70A to drive the adjustment light source device 10. The position adjustment luminous fluxes (R color light and B color light) corresponding to the R color light modulator 141R and the B color light modulator 141B are thus introduced into the R color light modulator 141R and the B color light modulator 141B, respectively.

After step S1Q, the drive control section 733 transmits a predetermined control signal to the drive section 70A to drive the provisional fixing section 60, thus positioning the LED modules 611 and 621 at their irradiation positions (step S1R).

Specifically, the drive control section 733 controls the driving of the rotating portion 6222 to position the support plate 6224 at its irradiation position.

Besides, in response to the model data (coordinate values of the irradiation positions of the LED modules 611) stored in the memory 734, the drive control section 733 controls the driving of the support member 612 of the first provisional fixing portion 61 to cause the support member 612 to slide along the rail 53A, thus positioning the LED modules 611 at their irradiation positions corresponding to the model.

Additionally, in response to the model data (coordinate values of the irradiation positions of the LED modules 621) stored in the memory 734, the drive control section 733 controls the driving of the moving portion 6223 to move the moving portion 6223 in a Y-axis direction, thus positioning the LED modules 621 at their irradiation positions corresponding to the model.

After step S1R, the drive control section 733 transmits a predetermined control signal to the drive section 70A to drive the LED modules 611 and 621 to emit ultraviolets, thus executing the provisional fixing of the light modulators 141 to the cross dichroic prism 144 (step S1S).

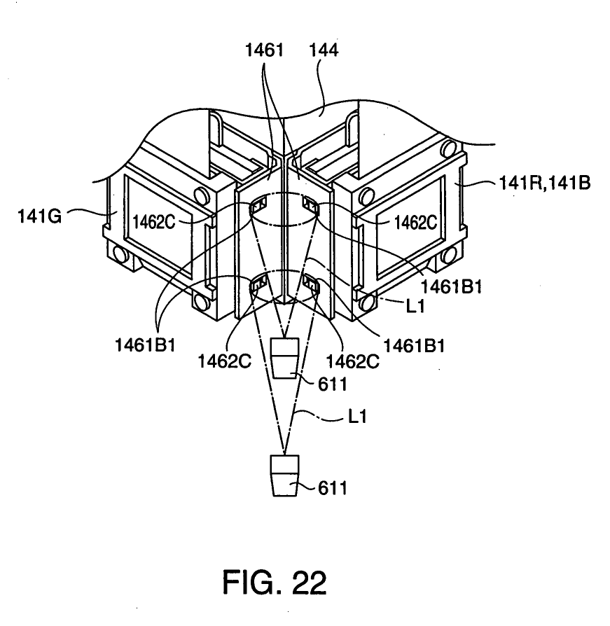

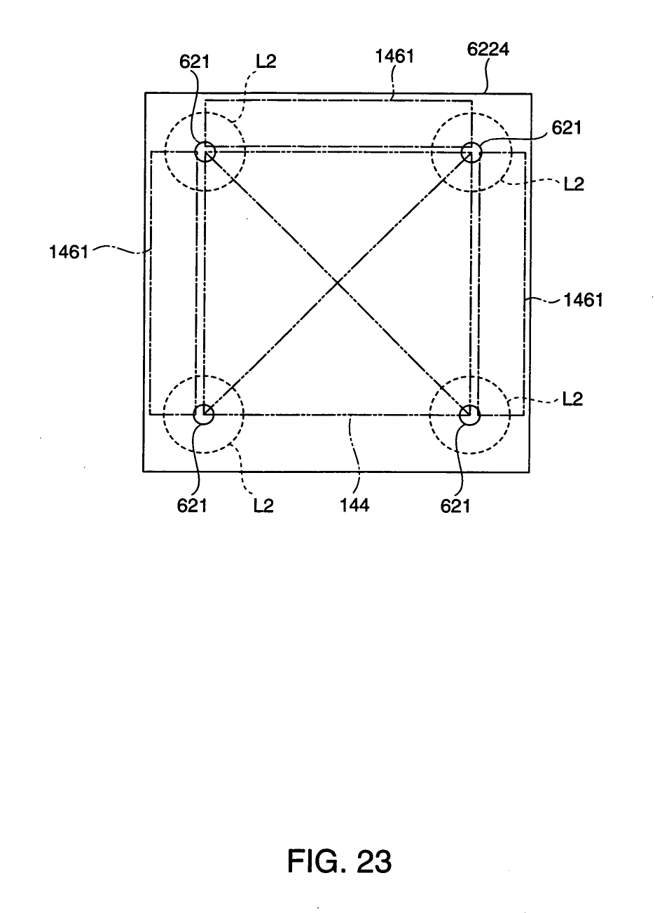

Specifically, FIGS. 22 and 23 are views illustrating the method of provisionally fixing the light modulators 141 to the cross dichroic prism 144 by the provisional fixing section 60.

For example, the drive control section 733 causes the LED modules 611, 621 to emit ultraviolets at an ultraviolet irradiance of 10 mmW/cm2 for 10 seconds.

As shown in FIG. 22, an ultraviolet L1 from each of the two LED modules 611 is emitted at a predetermined radiation angle, and the UV cure adhesive interposed between the upper and lower apertures 1461B1 formed in the first supports 1461 and the upper and lower raised portions 1462C of the second supports 1462 is cured to a predetermined strength.

As shown in FIG. 23, ultraviolets L2 from the four LED modules 621 are emitted at a predetermined radiation angle, and the UV cure adhesive interposed between the four corner positions in plan view of the cross dichroic prism 144 and the left and right side end portions of the luminous flux emergence side end face of each first support 1461 is cured to a predetermined strength.

This state is such that the ultraviolet L1, L2 emitted from each LED module 611, 621 does not completely cure the UV adhesive, but such that each light modulator 141 is provisionally fixed to the cross dichroic prism 144.

3-2. Fixing Method

After step S1, the permanent fixing of each light modulator 141 to the cross dichroic prism 144 is executed using the permanent fixing apparatus 3.

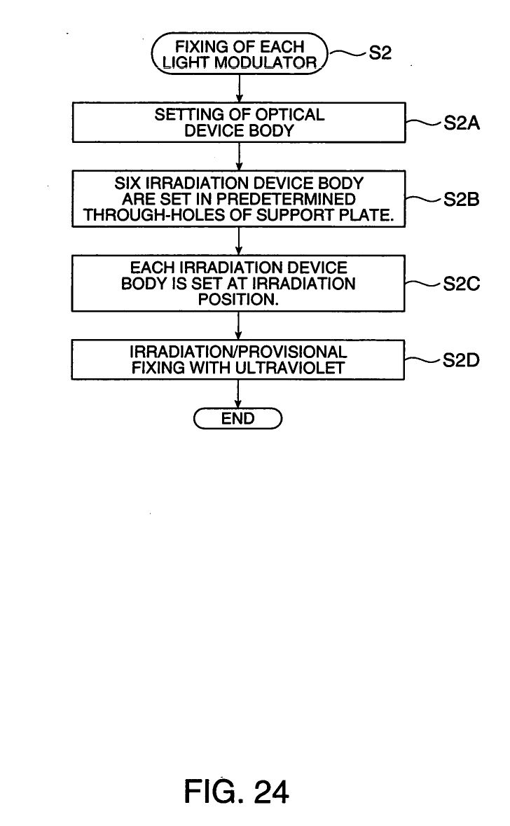

FIG. 24 is a flowchart illustrating the method of fixing each light modulator 141.

First, the operator removes the provisionally fixed optical device body 140A from the mounting section 50 of the adjustment apparatus 2, and sets it on the mounting section 50, of the permanent fixing apparatus 3 (step S2A).

After step S2A, the operator sets the six irradiation device bodies 821 of the second irradiation device 82 by inserting them into six out of the plurality of through-holes 822D1 of the support plate 822D which correspond to the model of the optical device body 140A (step S2B).

After step S2B, the operator operates the operation section 71′ of the irradiation control device 90 to execute an entry operation of intent to execute the permanent fixing of the light modulators 141. The control section 93 reads the program stored in the memory 933, as shown below, to start the permanent fixing of the light modulators 141.

First, the control section 93 controls the driving of the first irradiation device 81 and the second irradiation device 82 to position the irradiation device bodies 811 and 821 at their irradiation positions (step S2C).

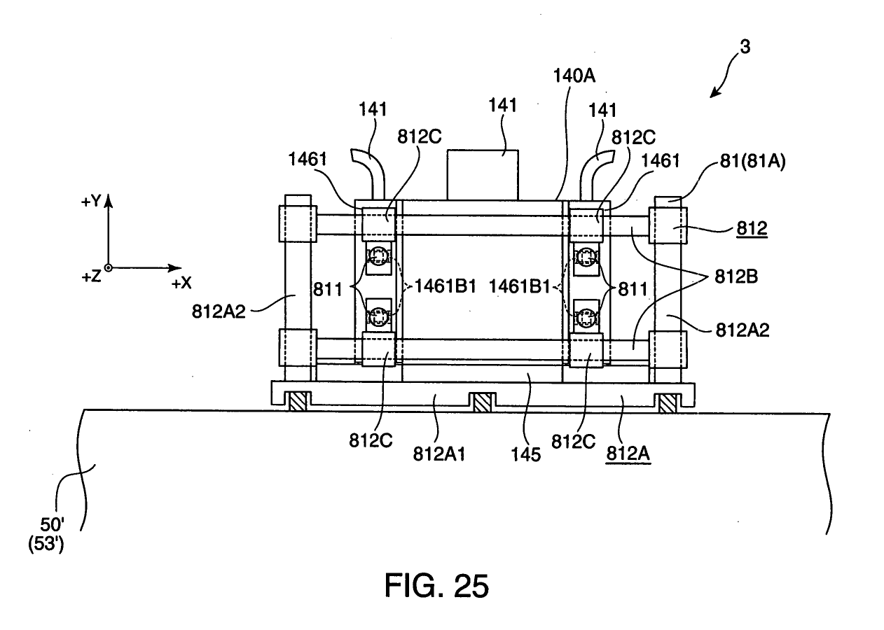

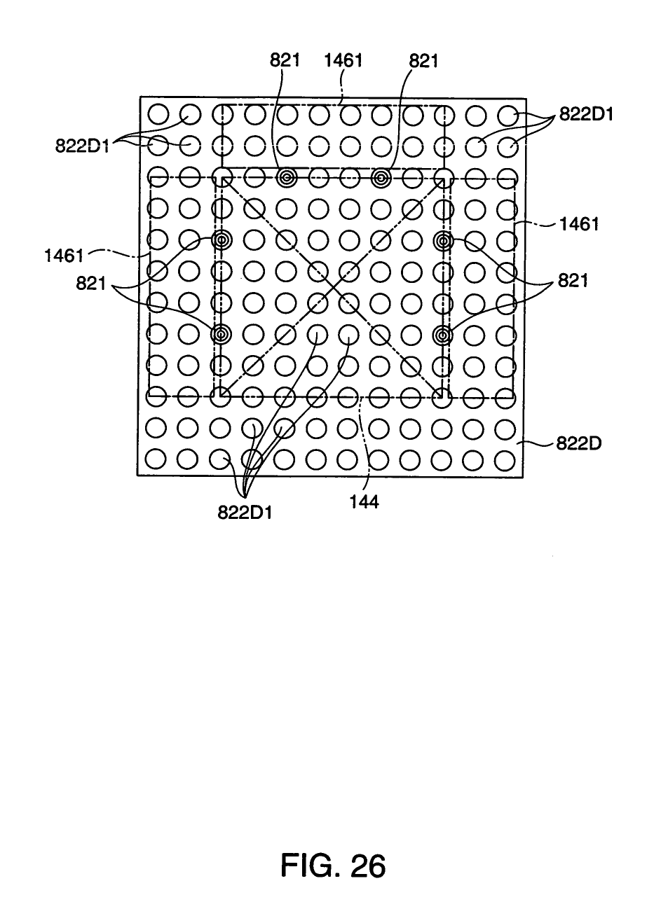

FIGS. 25 and 26 are views showing the irradiation device bodies 811 and 821 positioned at the irradiation positions.

Specifically, in response to the model data (the coordinate values of the irradiation positions of the irradiation device bodies 811) stored in the memory 933, the control section 93 transmits a predetermined control signal to the drive section 90A to drive the first moving portion 812A, the second moving portion 812B, and the third moving portion 812C. The control section 93 thus moves the irradiation device bodies 811 in the Z-axis direction (first axial direction), the Y-axis direction (second axial direction), and the X-axis direction (third axial direction), thus positioning the irradiation device bodies 811 at their respective irradiation positions. On this occasion, as shown in FIG. 25, the irradiation device bodies 811 are each positioned at a position opposite the apertures 1461B1 of each first support 1461.

In addition, the control section 93 transmits a predetermined control signal to the drive section 90A to drive the rotating portion 822B, thus positioning the support plate 822D at its irradiation position. Furthermore, in response to the model data (the coordinate values of the irradiation positions of the irradiation device bodies 821) stored in the memory, the control section 93 transmits a predetermined control signal to the drive section 90A to drive the first moving portion 822C. The control section 93 thus moves the irradiation device bodies 821 in the Y-axis direction (first axial direction) to position the irradiation device bodies 821 at their irradiation positions. On this occasion, as shown in FIG. 26, the irradiation device bodies 821 are opposite one another and spaced a predetermined distance from one another, in plan view, between the cross dichroic prism 144 and the first support 1461.

After step S2C, the control section 93 transmits a predetermined control signal to the drive section 90A to drive the LED module 811A of the irradiation device bodies 811 and 821. The control section 93 thus causes the LED modules 811A to emit ultraviolets, thus executing the permanent fixing of the light modulators 141 to the cross dichroic prism 144 (step S2D).

Specifically, the control section 93 causes the LED modules 811A to emit ultraviolets at a greater irradiance for a longer irradiation time than in the aforementioned step S1S, for example, in this embodiment, at an irradiance of 100 mmW/cm2 for 60 seconds.

The luminous fluxes emitted from the LED modules 811A of the first irradiation device 81 are collected by the collector 811B on the vicinity of the upper and lower apertures 1461B1 formed in each first support 1461. The U cure adhesive, interposed between the apertures 1461B1 and the upper and lower raised portions 1462C of the second support 1462, is thereby reliably cured.

Besides, the luminous fluxes emitted from the LED modules 811A of the second irradiation device 82 are collected by the collector 811B between the cross dichroic prism 144 and the first support 1461. The UV cure adhesive, interposed between the cross dichroic prism 144 and the first support 1461, is thereby reliably cured.

The optical device body 140A is thus manufactured using the above process.

In the first embodiment, the irradiation device bodies 811 and 821 of the first irradiation device 81 and the second irradiation device 82, which configure the permanent fixing apparatus 3, each include the LED module 811A serving as the light source which emits an ultraviolet. Therefore, unlike the existing case of using a mercury vapor lamp, there is no limitation, in the form of a discharge arc tube, a reflector, and the like, which therefore allows the size of the light source itself to be reduced. Besides, the LED module 811A is used, thereby enabling low power consumption of the permanent fixing apparatus 3.

In addition, the irradiation device bodies 811 and 821 each include the collector 811B. Therefore, an ultraviolet emitted from the LED module can be focused on a predetermined position, and there is thus no need to use the existing optical fiber. Consequently, an expensive optical fiber is not used, thereby enabling a reduction in the cost of manufacturing the permanent fixing apparatus 3, which can therefore reduce the cost of manufacturing the manufacturing apparatus 1.

Furthermore, the irradiation device bodies 811 and 821 each include the fixing member 811C made of aluminum, and the fixing member 811C and the LED module 811A are heat-transferably connected to one another. Therefore, the heat generated in the LED module 811A can be released to the fixing member 811C, which prevents the LED module 811A from sustaining thermal degradation, thus enabling increased longevity.

Still furthermore, the first irradiation device 81 and the second irradiation device 82 include the moving mechanisms 812 and 822. Therefore, the moving mechanisms 812 and 822 can make it easy to position the irradiation device bodies 811 and 821 at their irradiation positions opposite the apertures 1461B1 of each first support 1461 or at their opposing irradiation positions in plan view between the cross dichroic prism 144 and the first support 1461. Consequently, an ultraviolet can efficiently irradiate the apertures 1461B1 and between the cross dichroic prism 144 and the first supports 1461, and there is therefore no need to execute the existing troublesome operation of trailing an optical fiber around, which can improve convenience.

The moving mechanism 812 includes the first moving portion 812A, the second moving portion 812B, and the third moving portion 812C. Therefore, the irradiation device bodies 811 can be moved in the Z-axis direction (first axial direction), the Y-axis direction (second axial direction), and the X-axis direction (third axial direction) with a simple configuration and with ease. Consequently, the position of the collector 811B of each irradiation device body 811 when focusing a luminous flux can be positioned at each aperture 1461B1 with a simple configuration and with ease.

In addition, the moving mechanism 822 includes the first moving portion 822C and the support plate 822D, and the plurality of through-holes 822D1 are formed on the end face of the support plate 822D, which extends along an XZ plane, perpendicular to the Y-axis direction (first axial direction), along which the first moving portion 822C moves. Therefore, as the arrangement positions of the irradiation device bodies 821 relative to the plurality of through-holes 822D1 are changed as appropriate, the arrangement positions of the irradiation device bodies 821 can be changed along an XZ plane perpendicular to the Y-axis direction. Consequently, the position of the collector 811B of each irradiation device body 821 when focusing a luminous flux can be easily positioned between the cross dichroic prism 144 and each first support 1461. Besides, the moving mechanism 822 is adopted, thereby eliminating the need for the mechanism of moving the irradiation device bodies 821 along the XY plane, thus making it possible to easily manufacture the permanent fixing apparatus 3 and also to reduce its manufacturing cost.

Additionally, the aforementioned permanent fixing apparatus 3 is adopted for the manufacturing apparatus 1 for manufacturing the optical device body 140A, thereby making it possible to easily position the irradiation device bodies 811 and 821 at their irradiation positions corresponding to the model of the optical device body 140A, provided as the manufacturing target, i.e., corresponding to the size of the optical device body 140A, thus enabling the manufacture of various optical device bodies 140A.

### Second Embodiment

A second embodiment of the invention will now be described. In the following description, the same parts as those already described are identified by like reference numerals, thus the description is omitted.

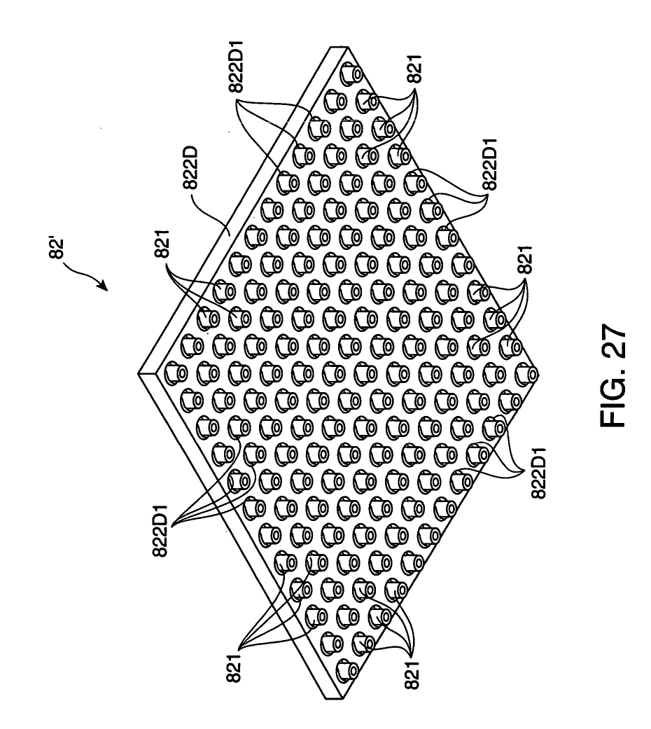

FIG. 27 is a perspective view showing the structure embodiment.

As shown in FIG. 27, this embodiment is different from the first embodiment in that a plurality of irradiation device bodies 821 are pre-placed in the plurality of through-holes 822D1 of the support plate 822D of the second irradiation device 82 described in the first embodiment. In accordance with this configuration, the control of the control section 93 over the plurality of irradiation device bodies 821 is also different from that of the first embodiment.

The following data is also included, as the model data, in the memory 933 of the control section 93.

That is, there are irradiation positions (coordinate values) corresponding to the model of the optical device body 140A and data having a table structure in which the coordinate values and the irradiation device bodies 821 are related to one another.

In manufacturing the optical device body 140A, in the aforementioned step S2D, to drive the LED modules 811A of the irradiation device body 821, out of a plurality of the irradiation device bodies 821, the arithmetic processing section of the control section 93 distinguishes six irradiation device bodies 821 from the others, which correspond to the irradiation positions, in response to the model data stored in the memory 933. The arithmetic processing section 931 then transmits, to the drive control section 932, signals corresponding to the six irradiation device bodies 821. And, in response to the signals transmitted from the arithmetic processing section 931, the drive control section 932 transmits a predetermined control signal to the drive section 90A to drive the LED modules of the six irradiation device bodies 821 distinguished by the arithmetic processing section 931. The six irradiation device bodies 821 are thus caused to emit ultraviolets.

In the second embodiment, the second irradiation device 82′ is adopted, thereby driving six irradiation device bodies 821, which correspond to the irradiation positions corresponding to the model of the optical device body 140A, out of a plurality of the irradiation device bodies 821. This can cause the six irradiation device bodies 821 to emit ultraviolets between the cross dichroic prism 144 and each first supports 1461. Consequently, as in the second irradiation device 82 described in the first embodiment, the operator can omit step S2B in which the six irradiation device bodies 821 are set by inserting them into six through-holes 822D1, which correspond to the irradiation positions responding to the model of the optical device body 140A, out of a plurality of the through-holes 822D1. The optical device body 140A. can therefore be swiftly and easily manufactured.

The invention has so far been described with the preferred embodiments. However, the invention is not limited to these embodiments, but can be improved in various ways and modified in design without departing from the scope of the invention.

In the aforementioned embodiments, the manufacturing apparatus 1 is configured of the adjustment apparatus 2 and the permanent fixing apparatus 3, but is not limited to this configuration. For example, in the aforementioned embodiments, the configuration may be such that the permanent fixing of the light modulators 141 to the cross dichroic prism 144 is executed by changing the irradiation time and intensity of an ultraviolet emitted by the provisional fixing section 60 of the adjustment apparatus 2. With such a configuration, the manufacturing apparatus 1 can be configured of only the adjustment apparatus 2.

In each aforementioned embodiment, the configuration of the permanent fixing apparatus 3 is not limited to the configuration described in each aforementioned embodiment.

For example, in each aforementioned embodiment, the fixing of the first support 1461 and the second support 1462 is executed by the first irradiation device 81, and the fixing of the cross dichroic prism 144 and the first support 1461 is executed by the second irradiation device 82, 82′. However, for example, the following configurations may be adopted.

For example, in each aforementioned embodiment, the first irradiation device 81 is used in place of the second irradiation device 82, 82′, and all the aforementioned fixings are executed by the first irradiation device 81. Conversely, for example, in each aforementioned embodiment, the second irradiation device 82, 82′ is disposed in place of the first irradiation device 81, and all the aforementioned fixings are executed by the second irradiation device 82, 82′.

Additionally, for example, in each aforementioned embodiment, the first irradiation device 81 and the second irradiation device 82, 82′ are reversed in arrangement position, and the fixing of the first support 1461 and the second support 1462 is executed by the second irradiation device 82, 82′, while the fixing of the cross dichroic prism 144 and the first support 1461 is executed by the first irradiation device 81.

Furthermore, for example, in each aforementioned embodiment, the second irradiation device 82′ described in the second embodiment is disposed in place of the first irradiation device 81, and the fixing of the first support 1461 and the second support 1462 is executed by the second irradiation device 82′. Similarly, in each second embodiment, the second irradiation device 82 described in the first embodiment is disposed in place of the first irradiation device 81, and the fixing of the first support 1461 and the second support 1462 is executed by the second irradiation device 82. Besides, the reversed in arrangement position.

In each aforementioned embodiment, the configuration of the adjustment apparatus 2 is not limited to the configuration described in each aforementioned embodiment.

For example, the configuration is provided with three six-axis position adjustment devices 30 in response to the light modulators 141, but is not limited thereto. The mounting section 50 is configured to be rotatable around the central position of the cross dichroic prism 144, and the configuration may thus be provided with only one six-axis position adjustment device 30.

Besides, for example, the luminous flux detection device 40 is omitted. A luminous flux projected from the optical device body 140A is enlarged and projected onto the screen by the projection lens 160 or a master lens having the standard optical characteristics of the projection lens 160. The six-axis position adjustment devices 30 are manually operated while observing an image projected on the screen, thus executing the position adjustment of the light modulators 141. Additionally, the configuration may be adopted in which the image projected on the screen is taken by the luminous flux detection device 40 or the like described in each aforementioned embodiment, and the driving of the six-axis position adjustment devices 30 is controlled based on the image taken.

In each aforementioned embodiment, the configuration is such that image light passed through the light modulator 141 (liquid crystal panel 1411) and the cross dichroic prism 144 is taken by each CCD camera 41, but is not limited thereto. For example, the configuration may be adopted in which the image light is received by a 3CCD camera which takes in the color lights of R, G, and B at one time and transmits three R, G, and R signals to the control section 73, or by an image pickup device such as a MOS (Metal-Oxide Semiconductor) sensor.

In each aforementioned embodiment, the permanent fixing apparatus 3 is used to fix the light modulators 141 to the cross dichroic prism 144, but the configuration is not limited thereto. The permanent fixing apparatus 3 may be used to fix the cross dichroic prism 144 to the support structural body 145.

In each aforementioned embodiment, the optical device body 140A is configured to include three light modulators 141, but is not limited to this configuration. The optical device body 140A may be configured to include two light modulators, or four light modulators or more. Besides, in the optical device body 140A, out of three luminous flux incidence side end faces of the cross dichroic prism 144, the G color light modulator is disposed on the luminous flux incidence side end face opposite the projection lens 160. And, the R color light modulator and the B color light modulator are disposed on the other two luminous flux incidence side end faces. However, the arrangement position is not limited thereto. For example, the configuration may be adopted in which the R color light modulator or the B color light modulator is disposed on the luminous flux incidence side end face opposite the projection lens 160.

Each aforementioned embodiment uses only the example of a front type projector which performs projection in the direction in which the screen is observed. However, the invention can also be applied to a rear type projector which performs projection in a direction opposite the direction in which the screen is observed.

The best configuration and the like for carrying out the invention are disclosed in the above description, but the invention is not limited thereto. That is, the invention is particularly illustrated and described mainly regarding specific embodiments. However, those skilled in the art can add, to the embodiments described above, various modifications in shape, material, quantity, and other detailed configurations without departing from the technical idea and object of the invention.

Accordingly, the description limiting the shapes, is illustrative to facilitate understanding of the invention, and is not intended to limit the invention. Therefore, the invention includes the description using the names of members free from part or all of such limitations on the shapes, the materials, and the like.

The ultraviolet irradiation apparatus according to the embodiments of the invention enables a reduction in size and an improvement in convenience, and is therefore useful as an ultraviolet irradiation apparatus to be used in a manufacturing apparatus for manufacturing an optical device of a projector.

The entire disclosure of Japanese Patent Application No. 2005-033263, filed Feb. 9, 2005 is expressly incorporated by reference herein.

What is claimed is:

1. An ultraviolet irradiation apparatus that emits a luminous flux in an ultraviolet region, comprising:
an irradiation device body including,
a self-luminous element that emits a luminous flux in an ultraviolet region,
a collector that is disposed on the luminous flux emergence side of the self-luminous element and focuses the luminous flux, and
a fixing member made of a metal material that connects between the self-luminous element and the collector, and connects the self-luminous element heat-transferably; and
a moving mechanism that supports the irradiation device body and that moves the irradiation device body in a direction toward and away from an irradiation target.

2. The ultraviolet irradiation apparatus according to claim 1,
the moving mechanism including,
a first moving section that is movable in a first axial direction toward and away from the irradiation target, and
a second and a third moving section that are movable in a second and a third axial direction perpendicular to the first axial direction, respectively.

3. The ultraviolet irradiation apparatus according to claim 1,
the moving mechanism including
a first moving section that is movable in a first axial direction toward and away from the irradiation target, and
a support plate that connected to the first moving section, and extends along a plane perpendicular to the first axial direction; wherein
a plurality of recesses that allow the irradiation device body to be fitted therein are formed in an end face of the support plate which extends along the plane.

4. The ultraviolet irradiation apparatus according to claim 1, wherein
a plurality of the irradiation device bodies are provided, wherein
the moving mechanism including
a first moving section that is movable in a first axial direction toward and away from the irradiation target, and
a support plate that connected to the first moving section, and extends along a plane perpendicular to the first axial direction; wherein
the plurality of irradiation device bodies are spaced a predetermined distance apart on an end face of the support plate which extends along the plane.

5. An optical device manufacturing apparatus for manufacturing an optical device including a plurality of light modulators that modulate each of plural color lights in response to image information and a color combination optical device that combines the color lights modulated by the light modulators to form an image light, the apparatus comprising:
a holding section that holds the color combination optical device;
a position adjustment section that holds the light modulators, and executes the position adjustment of the light modulators relative to the color combination optical device;
an adjustment light source device that introduces a position adjustment luminous flux into the light modulators; and
an ultraviolet irradiation apparatus according to claim 1 that emits a luminous flux in an ultraviolet region to cure a UV cure adhesive interposed between the light modulators and the color combination optical device.
